(19) United States
(12) Patent Application Publication
(10) Pub. No.: US 2026/0122613 A1
(43) Pub. Date: Apr. 30, 2026

(54) PAGING CONFIGURATION FOR RECEPTION OF DOWNLINK DATA

(71) Applicant: NOKIA TECHNOLOGIES OY, Espoo (FI)

(72) Inventors: Renato Barbosa Abreu, Aalborg (DK); Nitin Mangalvedhe, Hoffman Estates, IL (US); Rapeepat Ratasuk, Inverness, IL (US); Ali Karimidehkordi, Munich (DE); Knud Knudsen, Aabybro (DK)

(21) Appl. No.: 18/931,016

(22) Filed: Oct. 29, 2024

(51) Int. Cl. H04W 68/02; H04W 72/1273; H04W 72/23

(52) U.S. Cl. CPC H04W 68/02; H04W 72/1273; H04W 72/23

(57) ABSTRACT

A user device may receive from a network node, a first paging configuration for reception of a paging message associated with downlink data, wherein the downlink data is associated with a first priority level, and wherein the first paging configuration is different from a second paging configuration for reception of downlink data that is associated with a second priority level. The user device may receive a control channel, wherein the control channel schedules a data channel carrying the paging message for reception of the downlink data associated with the first priority level, and wherein the control channel comprises an indication that the paging message is for reception of the downlink data with the first priority level. The user device may receive the data channel, based on the first paging configuration, and receive the downlink data associated with the first priority level based on the received paging message.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. EUTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency. 6G and other networks are also being developed.

### SUMMARY

In some aspects, the techniques described herein relate to an apparatus including: at least one processor; and at least one memory storing instructions that, when executed by the at least one processor, cause the apparatus at least to perform: receiving from a network node, a first paging configuration for reception of a paging associated with downlink data, wherein the downlink data is associated with a first priority level, and wherein the first paging configuration is different from a second paging configuration for reception of downlink data that is associated with a second priority level; receiving a wake-up signal (WUS) indicating to monitor a paging for reception of the downlink data associated with the first priority level based on the first paging configuration; receiving, based on the first paging configuration, the paging for reception of the downlink data associated with the first priority level; and receiving the downlink data associated with the first priority level based on the received paging.

In some aspects, the techniques described herein relate to an apparatus including: at least one processor; and at least one memory storing instructions that, when executed by the at least one processor, cause the apparatus at least to perform: transmitting to a user device, a first paging configuration for reception of a paging associated with downlink data, wherein the downlink data is associated with a first priority level, and wherein the first paging configuration is different from a second paging configuration for reception of downlink data that is associated with a second priority level; transmitting a wake-up signal (WUS) indicating to monitor a paging for reception of the downlink data by the user device associated with the first priority level based on the first paging configuration; transmitting, based on the first paging configuration, the paging for reception of the downlink data associated with the first priority level; and transmitting the downlink data associated with the first priority level.

In some aspects, the techniques described herein relate to a method including: receiving, by a user device from a network node, a first paging configuration for reception of a paging associated with downlink data, wherein the downlink data is associated with a first priority level, and wherein the first paging configuration is different from a second paging configuration for reception of downlink data that is associated with a second priority level; receiving a wake-up signal (WUS) indicating to monitor a paging for reception of the downlink data associated with the first priority level based on the first paging configuration; receiving, based on the first paging configuration, the paging for reception of the downlink data associated with the first priority level; and receiving the downlink data associated with the first priority level based on the received paging.

In some aspects, the techniques described herein relate to a method including: transmitting, from a network node to a user device, a first paging configuration for reception of a paging associated with downlink data, wherein the downlink data is associated with a first priority level, and wherein the first paging configuration is different from a second paging configuration for reception of downlink data that is associated with a second priority level; transmitting a wake-up signal (WUS) indicating to monitor a paging for reception of the downlink data by the user device associated with the first priority level based on the first paging configuration; transmitting, based on the first paging configuration, the paging for reception of the downlink data associated with the first priority level; and transmitting the downlink data associated with the first priority level.

In some aspects, the techniques described herein relate to an apparatus including: at least one processor; and at least one memory storing instructions that, when executed by the at least one processor, cause the apparatus at least to perform: receiving from a network node, a first paging configuration for reception of a paging message associated with downlink data, wherein the downlink data is associated with a first priority level, and wherein the first paging configuration is different from a second paging configuration for reception of downlink data that is associated with a second priority level; receiving a control channel, wherein the control channel schedules a data channel carrying the paging message for reception of the downlink data associated with the first priority level, and wherein the control channel includes an indication that the paging message is for reception of the downlink data with the first priority level; receiving the data channel, based on the first paging configuration; and receiving the downlink data associated with the first priority level based on the received paging message.

In some aspects, the techniques described herein relate to an apparatus including: at least one processor; and at least one memory storing instructions that, when executed by the at least one processor, cause the apparatus at least to perform: transmitting to a user device, a first paging configuration for reception of a paging message associated with downlink data, wherein the downlink data is associated with a first priority level, and wherein the first paging configuration is different from a second paging configuration for reception of downlink data that is associated with a second priority level; transmitting a control channel, wherein the control channel schedules a data channel carrying the paging message for reception of the downlink data associated with the first priority level, and wherein the control channel includes an indication that the paging message is for reception of the downlink data by the user device with the first priority level; transmitting the data channel, based on the first paging configuration; and transmitting the downlink data associated with the first priority level.

In some aspects, the techniques described herein relate to a method including: receiving, by a user device from a network node, a first paging configuration for reception of a paging message associated with downlink data, wherein the downlink data is associated with a first priority level, and wherein the first paging configuration is different from a second paging configuration for reception of downlink data that is associated with a second priority level; receiving a control channel, wherein the control channel schedules a data channel carrying the paging message for reception of the downlink data associated with the first priority level, and wherein the control channel includes an indication that the paging message is for reception of the downlink data with the first priority level; receiving the data channel, based on the first paging configuration; and receiving the downlink data associated with the first priority level based on the received paging message.

In some aspects, the techniques described herein relate to a method including: transmitting, from a network node to a user device, a first paging configuration for reception of a paging message associated with downlink data, wherein the downlink data is associated with a first priority level, and wherein the first paging configuration is different from a second paging configuration for reception of downlink data that is associated with a second priority level; transmitting a control channel, wherein the control channel schedules a data channel carrying the paging message for reception of the downlink data associated with the first priority level, and wherein the control channel includes an indication that the paging message is for reception of the downlink data by the user device with the first priority level; transmitting the data channel, based on the first paging configuration; and transmitting the downlink data associated with the first priority level.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network.

FIG. 2A is a diagram illustrating LPWA as a fallback carrier for a broadband UE.

FIG. 2B is a diagram illustrating a LPWA deployment in-band to an eMBB carrier.

FIG. 3 is a diagram illustrating an example of a paging early indication.

FIG. 4 is a diagram illustrating example operation of LP-WUS.

FIG. 5 is a diagram illustrating a priority access for LPWA.

FIG. 6 is a diagram illustrating an aspect of an example embodiment.

FIG. 7 is a diagram illustrating an example of timeline using the first (enhanced) paging configuration triggered by a wake-up signal.

FIG. 8 is a diagram illustrating an aspect of an example embodiment.

FIG. 9 is a diagram illustrating an aspect of an example embodiment.

FIG. 10 is a diagram illustrating an aspect of an example embodiment.

FIG. 11A is a diagram illustrating an example of enhanced paging configuration triggered by WUS for a subgroup of UEs.

FIG. 11B is a diagram illustrating an example of enhanced paging configuration in combination with LP-WUS options for subgroups of UEs.

FIG. 12 is a flow chart illustrating operation of an apparatus (e.g., which may be a UE or user device, or other apparatus) according to an example embodiment.

FIG. 13 is a flow chart illustrating operation of an apparatus (e.g., which may be a gNB or network node, or other apparatus) according to an example embodiment.

FIG. 14 is a flow chart illustrating operation of an apparatus (e.g., which may be a UE or user device, or other apparatus) according to an example embodiment.

FIG. 15 is a flow chart illustrating operation of an apparatus (e.g., which may be a gNB or network node, or other apparatus) according to an example embodiment.

FIG. 16 is a block diagram of a wireless station or node (e.g., UE, user device, AP, BS, ENB, gNB, RAN node, network node, TRP, or other node) 1300 according to an example embodiment.

### DETAILED DESCRIPTION

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, unless stated explicitly, performing a step “in response to A” does not indicate that the step is performed immediately after “A” occurs and one or more intervening steps may be included.

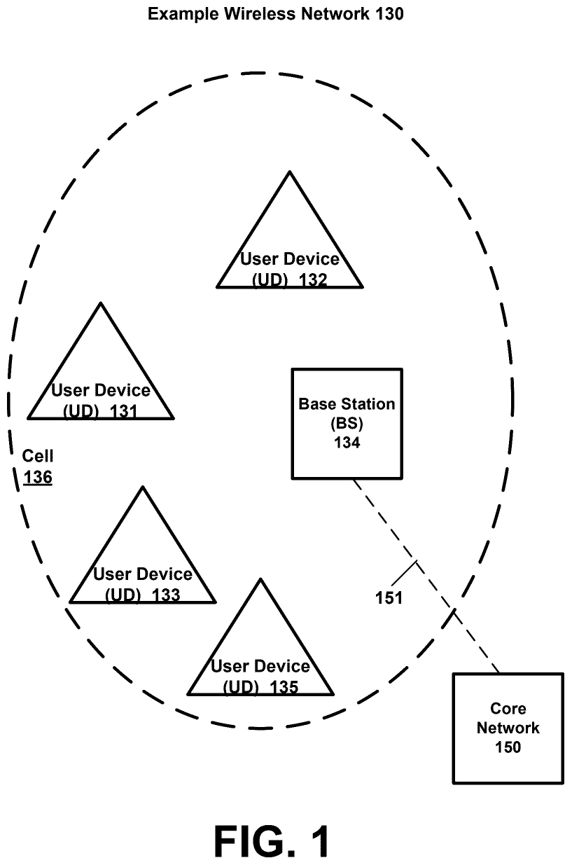

FIG. 1 is a block diagram of a wireless network 130. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as e.g., such as a centralized unit (CU) and/or a distributed unit (DU) in the case of a split BS or split gNB. At least part of the functionalities of a BS (e.g., access point (AP), base station (BS) or (c) Node B (cNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node.

Some functionalities of the communication network may be carried out, at least partly, in a central/centralized unit, CU, (e.g., server, host or node) operationally coupled to distributed unit, DU, (e.g., a radio head/node). Thus, 5G networks architecture may be based on a so-called CU-DU split. The gNB-CU (central node) may control a plurality of spatially separated gNB-DUs, acting at least as transmit/receive (Tx/Rx) nodes. In some embodiments, however, the gNB-DUs (also called DU) may comprise e.g., a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network (CN). Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10-5 and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as 5G (New Radio (NR)), cmWave, and/or mm Wave band networks, IoT, MTC, eMTC, eMBB, URLLC, 6G, etc., or any other wireless network or wireless technology. These example networks, technologies or data service types are provided only as illustrative examples.

A user device (or UE) may measure various signals and may transmit one or more measurement reports to the network. For example, a UE may measure reference signals received from one or more network nodes (e.g., gNBs or DUs), including channel state information-reference signals (CSI-RSs) and/or synchronization signal block (SSB) reference signals, demodulation references signals, and/or other reference signals. Based on received reference signals, the UE may measure various signal parameters, e.g., such as reference signal received power (RSRP), reference signal received quality (RSRQ), signal to interference plus noise ratio (SINR), received signal strength indicator (RSSI), or other signal parameter.

The PHY (physical) layer may refer to layer 1 (L1) and MAC (media access control) may refer to layer 2 (L2). RSRP, RSRQ, SINR and RSSI are signal quantities measured at layer 1 (L1). The UE may send L1 measurement reports (e.g., CSI-RS reports, which include measurements of one or more signal parameters for one or more cells) to a gNB, source DU or serving cell. These L1 measurement reports may be sent periodically, for example, or aperiodically. L1/L2 measurement reports may include no averaging or filtering of measurement values or may include less averaging or filtering than what is performed for L3 measurement reports. L1 (or L1/L2) measurement reports may be transmitted by a UE to a serving network node or source DU and may cause the network node to trigger or initiate a L1/L2 triggered mobility (LTM) handover of the UE to another cell. L1 measurements (e.g., RSRP RSRQ, RSSI) may be provided or reported periodically to the DU (MAC/PHY).

In an example, sounding reference signal (SRS) transmissions and non-zero power (NZP)-CSI-RS measurements may be used for assessing the channel quality, performing measurements related to beam management and mobility, and/or the like. For example, the CSI components may include at least one of the following: channel quality information (CQI), precoding matrix indicator (PMI), CSI-RS resource indicator (CRI), synchronization signal SS/PBCH resource block indicator (SSBRI), layer indicator (L1), rank indicator (RI), L1-RSRP, and/or the like.

A configured NZP-CSI-RS resource may correspond to up to 32 NZP-CSI-RS antenna ports in NR. For example, there may be up to 32 different antenna ports multiplexed in time and frequency within the overall CSI-RS resource.

In wireless communications, an antenna port may represent a unique logical interface through which signals may be transmitted or received by a physical antenna or a group of antennas. For 5G NR, the use of different antenna ports may enable various transmission and reception scenarios, allowing for advanced functionalities like beamforming, MIMO (Multiple Input Multiple Output), and more.

In an example, the UE may use antenna ports associated with the reference signal resource(s) for channel estimation for downlink transmissions and for determining related channel state information (CSI). In other words, each individual downlink transmission of reference signal or channel may be carried out by using a specific antenna port, the identity of which is known to the UE.

In an example, a structure in the antenna port numbering may be used such that antenna ports for different purposes have numbers in different ranges. For example, downlink antenna ports starting with 1000 may be used for PDSCH. Different transmission layers for PDSCH can use antenna ports in this series, for example 1000 and 1001 for a two-layer PDSCH transmission. In an example, downlink antenna ports in the 3000 series may be used for the CSI-RS.

In an example embodiment, Internet of things (IoT) may refer to the interconnection and the autonomous exchange of data between devices. Three main IoT categories may include massive IoT, critical IoT, and broadband IoT. For example, the massive IoT may be deployed in applications such as smart meters, asset tracking and management, fleet management, sensors, remote monitoring, smart cities, and/or the like. In cellular systems, massive IoT deployment may be supported via low power wide area (LPWA) network. In 4G LTE, LPWA network based on NB-IoT and LTE-M technologies were introduced. The LPWA have the following characteristics: low device complexity/cost, low device power consumption enabling long battery life of greater than 10 years, enhanced coverage compared to broadband services (up to 20-25 dB enhanced coverage), support for massive number of devices, delay tolerant data transmission, and infrequent data transmissions.

In an example, a UE may switch from a broadband carrier or bandwidth part (BWP) to a LPWA carrier (or a narrowband carrier) or BWP when the cell can no longer support broadband services.

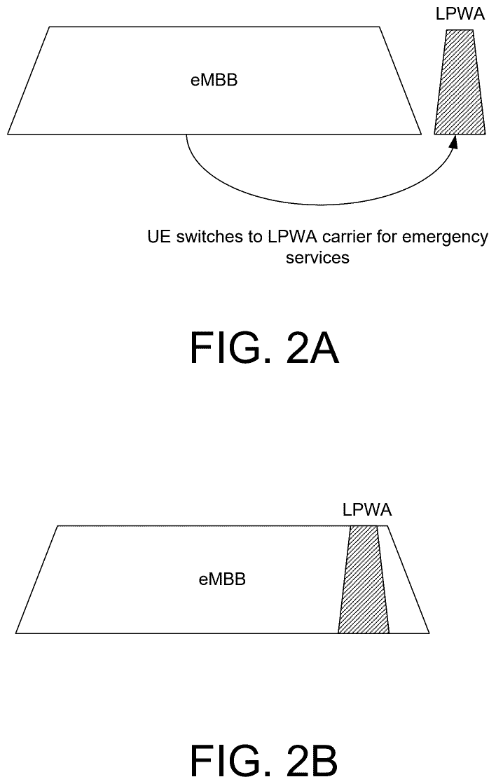

FIG. 2A is a diagram illustrating LPWA as a fallback carrier or BWP for a broadband UE. In this example, an enhanced mobile broadband (eMBB) carrier is separated from a LPWA carrier.

FIG. 2B is a diagram illustrating a LPWA deployment in-band to an eMBB carrier. In an example, the LPWA carrier may be deployed in-band to eMBB carrier. This allows for efficient spectral usage, especially in the early LPWA deployment stage where there might not be large number of LPWA devices (IoT UEs) in the system.

In an example, LPWA carrier/cell may have significantly enhanced coverage compared to eMBB carrier. To efficiently support UEs at various radio link coverage conditions, the LPWA cell may support multiple coverage enhancement (CE) levels. This then allows the UE to access the cell at the suitable coverage enhancement level. For example, LTE-M and NB-IoT may support up to 3 different CE levels that can be configured by the network. Table 1 illustrates examples of the CE level configuration by the network based on the maximum coupling loss (MCL) that is determined based on a RSRP measurement by the UE. In the example shown in Table 1, CE0 may be used by the UE in normal coverage (e.g., UE with RSRP measurement above a configured threshold). CE1 may be used by a UE requiring up to 10 dB enhancement from normal coverage, while CE2 may be used by a UE requiring from 10 dB to 20 dB coverage enhancement. For each CE level, the network may configure different resources (e.g., time-frequency resources for physical random access channel (PRACH), physical downlink control channel (PDCCH)), different number of maximum repetitions (e.g., for PRACH, physical uplink shared channel (PUSCH), PDCCH, physical downlink shared channel (PDSCH)), and different radio configurations (e.g., modulation and coding scheme (MCS) table, resource allocation schemes, modulation schemes, number of re-transmissions, and/or the like).

TABLE 1
CE mode configuration by the network.

| Coverage | |
|---|---|
| Enhancement | |
| Level | Configuration |
| CE0 | Normal (e.g. for UE with MCL |
| | up to 144 dB) |
| CE1 | Enhanced (e.g. for UE with MCL |
| | between 144 and 154 dB) |
| CE2 | Extreme (e.g. for UE with MCL |
| | between 154 and 164 dB) |

In an example, in order to receive a paging or a paging occasion (PO), a UE may need to wake up before the PO (e.g., in a next DRX-on period) to read 1-3 SSB bursts prior to PO to ensure time-frequency synchronization with the network (to be ready to decode paging record in a downlink data channel, such as for example, PDSCH). In addition, if many UEs share the same PO (e.g., read the same paging DCI) a rate of false-paging alarm may increase. For example, most UEs in the PO may not find their UE_ID in the paging record. These factors may result in waste of energy for UEs monitoring for paging in a cell.

In an example, a paging early indication (PEI) mechanism may be employed.

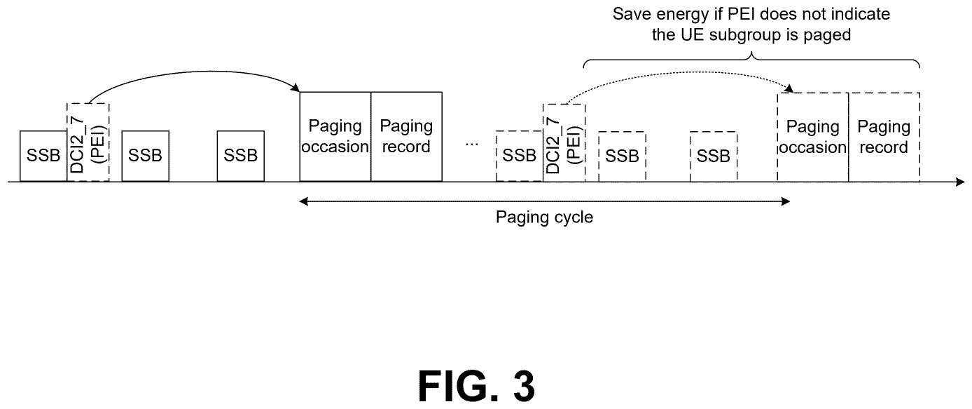

FIG. 3 is a diagram illustrating an example of a paging early indication. To address the issue of waking up before the paging, the paging early indication (PEI) mechanism may be employed. The PEI may act as a wake-up signal (WUS) which may indicate in advance whether the UE subgroup is to be paged. Therefore, the UE may only wake-up for synchronizing and monitoring the PO in case its subgroup is indicated in the PEI. In an example, the PEI may be transmitted in a DCI format 2_7 and may be configured for a UE subgrouping of up to 8 subgroups per PO.

In an example, a wake-up receiver (WUR) may be a low-power receiver designed to detect the WUS and wake up the main receiver (MR) from a low-power state to monitor POs only when necessary. Therefore, implementation of WUS may enhance power-saving capabilities.

In an example, a low power WUS (LP-WUS) operation of the UE in RRC-IDLE or RRC-INACTIVE mode may may be supported.

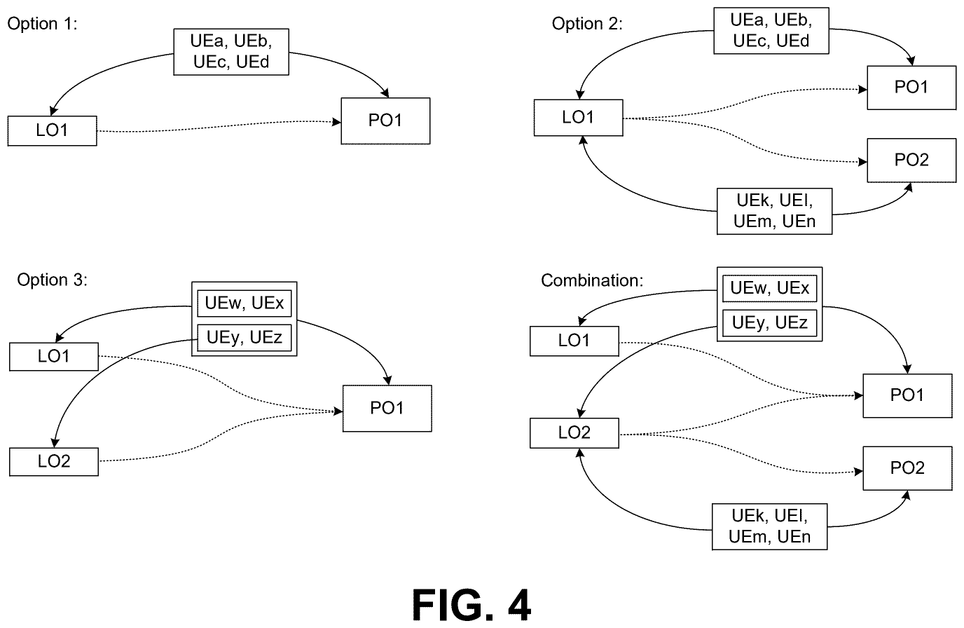

FIG. 4 is a diagram illustrating example operation of LP-WUS. In an example, a low power WUS (LP-WUS) operation in RRC-IDLE/INACTIVE mode may include the following. In an example, UEs monitoring the same PO may be divided into multiple subgroups, where LP-WUS may provide wake-up indication for each subgroup. In an example, the following options may be applicable.

As shown in FIG. 4, option 1 depicts UEs monitoring the same PO may monitor the same LP-WUS occasion (LO).

As shown in FIG. 4, option 2 depicts UEs corresponding to different POs may monitor the same LO.

As shown in FIG. 4, option 3 depicts UEs monitoring the same PO may be divided into multiple sets of subgroups, wherein the UEs within each set of subgroups may monitor the same LO.

In another example as shown in FIG. 4, combinations of the above options may be implemented.

In an example embodiment, a priority access mode may be employed. The priority access mode may allow the UE to perform faster (lower delay/latency) initial access based on priority of UE traffic.

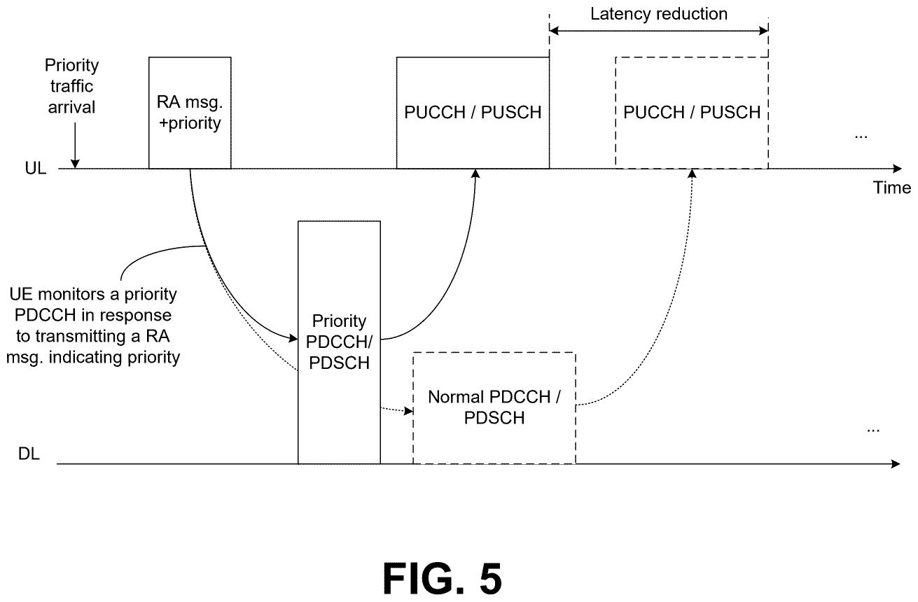

FIG. 5 is a diagram illustrating a priority access for a LPWA. In an example, the UE may be configured with at least two access configurations, one for priority access and another for normal access. The UE may select the priority access in case of priority data transmission and then the UE may transmit a priority indication to a gNB via a random access message, e.g., with a preamble. In response to transmitting the priority indication, the UE may monitor the control channel and perform remaining random access steps using the priority access configuration, e.g., with a higher bandwidth control resource set (CORESET) and bandwidth part (BWP) for receiving subsequent messages such as RAR, RRC messages, and/or Msg2/MsgB/Msg4.

In an example, the network may determine to minimize resource usage for the LPWA (e.g., to prioritize eMBB traffic) and conserve UE battery life (e.g., to configure UE with small CORESET size and infrequent control channel monitoring). Doing so may increase latency. Therefore, a problem may arise when some IoT messages (or data) types such as critical alarms, fault reports, emergency reports, remote commands, and/or the like require lower latency transmission.

In existing technologies, IoT traffic may be treated the same. For example, existing paging procedures do not allow prioritization of delay sensitive/critical data transmission. In an example, when a UE receives paging, the UE may determine to establish or resume a connection. Then, the UE may indicate a cause during a RRC connection establishment (or resume) to indicate a priority. In an example, the UE may establish/resume a RRC connection with an access identity to indicate a priority request. However, during a paging procedure, high priority traffic is not treated differently than normal traffic. As a result, the UE may decode a paging and based on a paging cause the UE may perform an appropriate procedure for a priority access/connection. However, for the case of a delay critical data transmission, the data transmission may not be performed within the required delay threshold. In an example, the data transmission may include transmission of critical IoT traffic, small data transmission (SDT), early data transmission (EDT), procedure(s) for transmission of infrequent small packets (e.g., 100 bytes), and/or the like. Therefore, when delay sensitive data transmission is not performed according to the delay requirements, performance degradation may occur, and/or transmitted data may not be relevant or valid.

Therefore, a method for prioritization of paging for reception of high priority data (downlink data) may be beneficial to ensure that requirements of delay sensitive downlink data are met.

Example embodiments are directed to improvement of paging operation by enhancements of paging configuration such that paging for reception of high priority data may have a different configuration than paging for normal data or low priority data. Additionally, or alternatively, example embodiments may include methods for an enhanced wake-up procedure for receiving a downlink (DL) data with a different configuration compared to normal data, e.g., with larger bandwidth resulting in low latency for priority DL data.

Therefore, techniques are provided for an enhanced paging configuration thereby enabling the UE to receive high priority downlink data with a shorter delay. In an example embodiment, a UE may receive from a network node (e.g., a base station (BS), a cell of the base station, an eNB, a gNB, a gNB-DU, and/or the like), a first paging configuration. In an example, the first paging configuration may be for reception of a paging associated with downlink data. In an example, the downlink data may be associated with a first priority level. For example, the first priority level may be a high priority level, an enhanced priority level, and/or the like. In an example, the first paging configuration may be different from a second paging configuration for reception of downlink data that is associated with a second priority level. For example, the second priority level may be a low priority level, a normal priority level, and/or the like. In an example, the UE may receive from the network node, a wake-up signal (WUS) indicating to monitor a paging for reception of the downlink data associated with the first priority level based on the first paging configuration. For example, the monitoring may be based on the first paging configuration. In an example, the UE may receive from the network node, based on the first paging configuration, the paging for reception of the downlink data associated with the first priority level. In an example, the UE may receive the downlink data associated with the first priority level based on the received paging.

Therefore, when example embodiments are implemented, the UE may be enabled to wake up in different modes. For example, a UE that employs a higher bandwidth may be able wake up for receiving a priority downlink data (or SDT) with lower latency.

In an example, the UE may receive information of mapping between the WUS and a paging configuration. For example, a first WUS may indicate monitoring the paging for reception of the downlink data associated with the first priority level based on the first paging configuration. As another example, a second WUS may indicate monitoring the paging for reception of the downlink data associated with the second priority level based on the second paging configuration.

In an example, the UE may monitor for the WUS. In an example, the indicating by the WUS may be based on a single bit indicated by the WUS. For example, the single bit may be conveyed by an ON/OFF keying, a high/low signal level, and/or the like.

In an example, the WUS indicating to monitor the paging for reception of the downlink data associated with the first priority level may be associated with an enhanced paging early indication radio network temporary identifier (ePEI-RNTI).

In an example, if WUS is configured, the UE may monitor for WUS which may indicate whether to further monitor paging (e.g., both monitoring a control channel, such as for example, PDCCH, in the paging occasion and receiving the corresponding data channel, such as for example, PDSCH, containing the paging record) with first (or enhanced) paging configuration. Alternatively, whether or not WUS is configured, the PDCCH sent by the network in the PO may indicate whether to receive the corresponding PDSCH that may include the paging record with the first paging configuration. In an example, if the WUS indicates whether to monitor paging with the first paging configuration, this indication may be provided by 1) a bit indicating the first paging configuration (versus the second paging configuration) in the payload of the WUS signal (and possibly for each sub-group of each PO); 2) by associating with an RNTI for the first paging configuration, e.g., ePEI-RNTI (versus normal PEI-RNTI); 3) by associating with a dedicated WUS time-frequency occasion for WUS which may indicate to monitor paging with the first paging configuration; 4) by associating with a dedicated WUS sequence for WUS which indicates to monitor paging with the first paging configuration.

In an example, the WUS may indicate to the UE to monitor the paging for reception of the downlink data associated with the first priority level. For example, the indication may be associated with a dedicated WUS time-frequency occasion. In another example, the WUS indicating to monitor the paging for reception of the downlink data associated with the first priority level may be associated with a dedicated WUS sequence. For example, the reception of the paging (or paging message) for reception of the downlink data associated with the first priority level may be based on receiving the dedicated WUS sequence.

In an example, the first paging configuration may be different from the second paging configuration. In an example, the first paging configuration of the paging may include at least one of a first configuration information of a paging control channel (PCCH), a first information of a paging occasion, a first information of a paging frame, a first configuration of a control channel scheduling a data channel carrying a paging message, a first configuration of the data channel, a first configuration of a random access channel (RACH), a first configuration of a bandwidth part (BWP), a first configuration of a control resource set (CORESET), a first information of a discontinuous reception (DRX) cycle, a first information of a search space, a first information of a paging radio network temporary identifier (P-RNTI), a first information of synchronization parameters, and/or the like.

In an example, the second paging configuration (different from the first paging configuration) may include at least one of a second configuration information of a paging control channel (PCCH), a second information of a paging occasion, a second information of a paging frame, a second configuration of a control channel scheduling a data channel carrying the paging, a second configuration of the data channel, a second configuration of a random access channel (RACH), a second configuration of a bandwidth part (BWP), a second configuration of a control resource set (CORESET), a second information of a discontinuous reception (DRX) cycle, a second information of a search space, a second information of a paging radio network temporary identifier (P-RNTI), a second information of synchronization parameters, and/or the like.

In an example embodiment, the first paging configuration and the second paging configuration may be associated with a same paging control channel (PCCH) with a same paging occasion (PO) and paging frame (PF).

In an example embodiment, the UE may receive information indicating a validity period associated with at least one of the first paging configuration or the second paging configuration. In another example, the UE may receive information indicating a validity condition associated with at least one of the first paging configuration or the second paging configuration. For example, the validity condition may be based on at least one of a battery level of the UE, a mobility state/condition or the UE, and/or the like.

In an example, the first paging configuration may be for (or associated with) an enhanced paging for reception of downlink data. The downlink data may be associated with the first priority level. In an example, the second paging configuration may be for a normal paging for reception of downlink data associated with the second priority level. For example, the enhanced paging may have a higher bandwidth than a normal paging associated with the second paging configuration. In an example, paging occasions of the enhanced paging may be associated with a higher bandwidth than paging occasions of the normal paging. In an example, a periodicity of the enhanced paging may be shorter than a periodicity of the normal paging. In another example, a time period of the enhanced paging may be shorter than a time period of the normal paging. In an example, the enhanced paging may use a larger downlink bandwidth part (BWP) than the normal paging.

In an example, the UE may receive from the network node the first paging configuration or the second paging configuration via at least one of a system information block (SIB), a radio resource control (RRC) message, and/or the like. For example, the SIB may be transmitted by broadcast, multicast, unicast, and/or the like.

In an example, the first priority level (or an enhanced priority level) may include at least one of a priority level associated with a queuing policy with lower queuing delay, a priority level associated with a bandwidth allocation policy that results in lower transmission delay, a priority level associated with a time sensitive communication (TSC), a high priority level, a priority level based on an integer value (e.g., a lower integer value indicates a higher priority level), and/or the like. In an example, the second priority level may include at least one of a low priority level, a priority level associated with a delay tolerant communication, and/or the like.

In an example, the UE may perform a random access procedure for a priority access (e.g., based on receiving the paging for reception of the downlink data associated with the first priority level, e.g., the enhanced paging). In an example, the priority access may include selecting a priority access configuration in response to receiving the paging for reception of downlink data associated with the first priority level. In an example, the UE may transmit to the network node, a random access message comprising an indication to select the priority access configuration. In an example, the UE may monitor a physical downlink control channel based, at least in part, on the priority access configuration.

In an example, the UE may receive the paging from the network node. In an example, the reception of the paging may include receiving, based on the first paging configuration, a control channel. For example, the control channel may schedule a data channel carrying the paging or a paging message for reception of the downlink data associated with the first priority level. In an example, the reception of the paging (or the paging message) may include receiving the data channel based on the first paging configuration.

In an example, the control channel may include an indication of whether a downlink control information (DCI) corresponds to the data channel scheduled for an enhanced paging, and whether to monitor the data channel for a normal paging or for an enhanced paging. In an example, the enhanced paging may include the paging for reception of the downlink data associated with the first priority level. In an example, the normal paging may include the paging for reception of the downlink data associated with the second priority level.

In an example, the indication (e.g., by the WUS) may include at least one of a single bit, a cyclic redundancy check (CRC) scrambled by an enhanced paging RNTI (eP-RNTI), or a P-RNTI associated with the enhanced paging or the normal paging. Regardless of whether WUS is configured, the indication of the first paging configuration may be provided in the PDCCH sent in the PO. This indication may be provided by a bit in the PDCCH indicating whether the DCI corresponds to PDSCH scheduled with the enhanced paging configuration. The indication may also be provided by scrambling the CRC of the PDCCH with a new enhanced paging RNTI (e.g., eP-RNTI), such that if the PDCCH is successfully decoded using this RNTI, the DCI corresponds to PDSCH scheduled with the first paging configuration.

In an example, the UE may transmit to the network node or the gNB, a capability indication of an enhanced paging support for reception of downlink data associated with the first priority level. In an example, the first priority level may be an enhanced priority level and the second priority level may be a normal priority level. The UE may transmit the capability indication to the network (e.g., the gNB, BS, a core network node, and/or the like) via a RRC message, a non-access stratum (NAS) message, and/or the like.

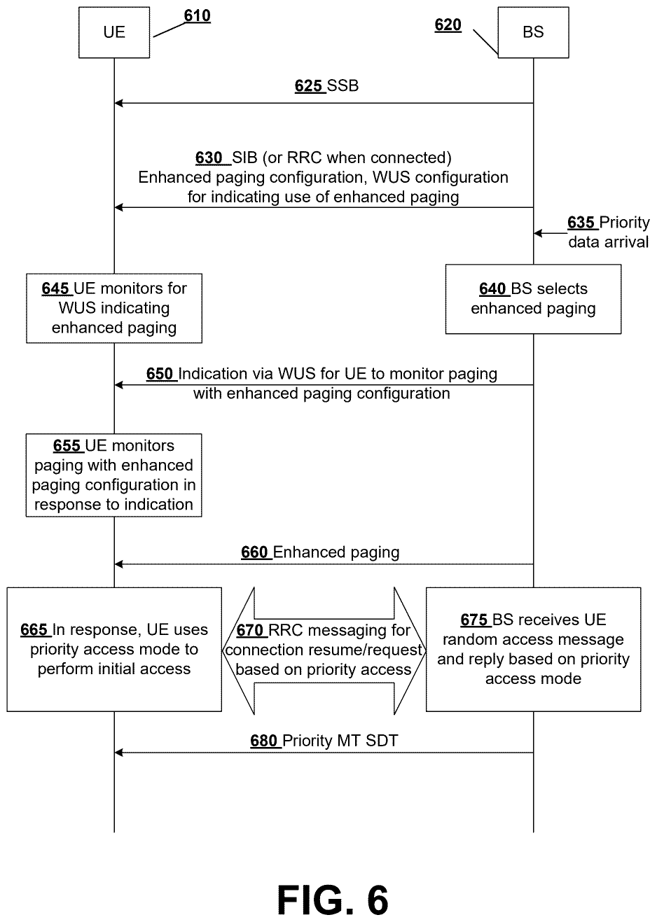

FIG. 6 is a diagram illustrating an aspect of an example embodiment. At 625, the UE 610 may receive synchronization signal block (SSB) from a base station (BS) 620. At 630, the UE 610 may receive a SIB message or a RRC message from the BS 620. In an example, the SIB or the RRC message may include WUS configuration, a first paging configuration (or enhanced paging configuration) for reception of a paging associated with downlink data with a first priority level (e.g., enhanced priority), a second paging configuration for reception of downlink data that is associated with a second priority level, and/or the like. At 635, the BS 620 may receive high priority downlink data to be transmitted to the UE 610. At 640, the BS 620, may determine to perform an enhanced paging. At 645, the UE 610 may monitor for WUS, e.g., to receive an indication of enhanced paging. At 650, the BS 620 may send a WUS with an indication of enhanced paging, e.g., indicating to monitor a paging for reception of the downlink data associated with the first priority level based on the first paging configuration. At 655, in response to the WUS, the UE 610 may monitor paging based on the first paging configuration, e.g., the enhanced paging configuration. At 660, the UE 610 may receive the paging for reception of the downlink data associated with the first priority level. At 665, the UE 610 may determine to perform a priority access. The UE 610 may perform random access procedure for priority access. At 670, the UE 610 may transmit one or more RRC messages to establish or resume a RRC connection. At 675, the BS 620 may receive a random access request from the UE 610 with an indication of priority access. At 680, the UE 610 may receive from the BS 620, (high) priority downlink data (or SDT).

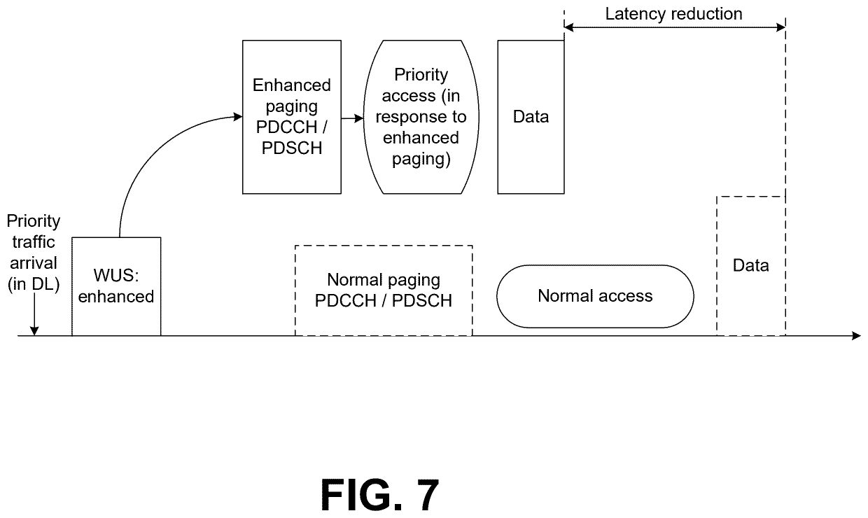

FIG. 7 is a diagram illustrating an example of timeline using the first (enhanced) paging configuration triggered by a wake-up signal. As shown in the figure, an example of timeline when enhanced paging configuration is applied in response to WUS indication, indicates a reduction in latency. For example, the reduction in latency may be achieved by faster paging PDCCH and paging record (PR) reception (e.g., with higher bandwidth) and an additional reduction may be provided by causing the UE to use a priority access configuration for resuming/requesting a connection.

Example embodiments are further directed to enhancement of a control channel for reception of paging for reception of high priority downlink data. In an example embodiment, a UE may receive from a network node (e.g., a gNB, a BS, an eNB, a gNB-DU, and/or the like), a first paging configuration for reception of a paging message associated with downlink data. In an example, the downlink data may be associated with a first priority level (e.g., high priority level, or enhanced priority level). In an example, the first paging configuration may be different from a second paging configuration for reception of downlink data that is associated with a second priority level. In an example, the second priority level may be a low priority level or a normal priority level. In an example, the UE may receive from the network node a control channel. In an example, the control channel may schedule a data channel that may carry a paging or the paging message for reception of the downlink data associated with the first priority level. In an example, the control channel may include an indication that the paging message is for reception of the downlink data with the first priority level. In an example, the UE may receive from the network node the data channel, e.g., based on the first paging configuration. In an example, the UE may receive from the network node, the downlink data associated with the first priority level based on the received paging message (or paging).

Therefore, when example embodiments are implemented, the UE may be enabled to use different paging configurations based on a priority of the downlink data. For example, a UE that employs a higher bandwidth may be able wake up for receiving a (high) priority downlink data (or SDT) with lower latency.

In an example, the first paging configuration may be different from the second paging configuration. In an example, the first paging configuration may include at least one of a first configuration information of a paging control channel (PCCH), a first information of a paging occasion, a first information of a paging frame, a first configuration of a control channel scheduling a data channel carrying the paging message, a first configuration of the data channel, a first configuration of a random access channel (RACH), a first configuration of a bandwidth part (BWP), a first configuration of a control resource set (CORESET), a first information of a discontinuous reception (DRX) cycle, a first information of a search space, a first information of a paging radio network temporary identifier (P-RNTI), a first information of synchronization parameters, and/or the like.

In an example, the second paging configuration (that may be different from the first paging configuration) may include at least one of a second configuration information of a paging control channel (PCCH), a second information of a paging occasion, a second information of a paging frame, a second configuration of a control channel scheduling a data channel carrying the paging message, a second configuration of the data channel, a second configuration of a random access channel (RACH), a second configuration of a bandwidth part (BWP), a second configuration of a control resource set (CORESET), a second information of a discontinuous reception (DRX) cycle, a second information of a search space, a second information of a paging radio network temporary identifier (P-RNTI), a second information of synchronization parameters, and/or the like.

In an example, the first paging configuration and the second paging configuration may be associated with a same paging control channel (PCCH) with a same paging occasion and paging frame.

In an example, the control channel scheduling the data channel may include a PDCCH that may include an indication of whether to monitor a PDSCH for a normal paging or monitor a PDSCH for an enhanced paging. For example, the indication may be at least one of a single bit, a P-RNTI associated with the enhanced paging or the normal paging, and/or the like. In an example, the PDSCH may include an indication of the enhanced paging.

In an example, the UE may receive from the network node or the gNB, information indicating a validity period associated with at least one of the first paging configuration or the second paging configuration. In an example, the UE may receive from the network node or the gNB, information indicating a validity condition associated with at least one of the first paging configuration or the second paging configuration. For example, the validity condition may be based on at least one of a battery level of the UE, a mobility condition/state of the UE, and/or the like.

In an example, the first paging configuration may be for (or associated with) an enhanced paging for reception of downlink data associated with the first priority level (or enhanced priority level). In an example, the second paging configuration may be for a normal paging for reception of downlink data associated with the second priority level. For example, the enhanced paging may have a higher bandwidth than a normal paging associated with the second paging configuration. In an example, paging occasions of the enhanced paging may be associated with a higher bandwidth than paging occasions of the normal paging. In another example, a periodicity of the enhanced paging may be shorter than a periodicity of the normal paging. In an example, a time period of the enhanced paging may be shorter than a time period of the normal paging. In an example, the enhanced paging may use a larger downlink bandwidth part (BWP) than the normal paging.

In an example, the UE may receive from the network node, the first paging configuration or the second paging configuration via at least one of a system information block (SIB), a radio resource control (RRC) message, and/or the like.

In an example, the first priority level (or the enhanced priority level) may include at least one of: a priority level associated with a queuing policy with lower queuing delay, a priority level associated with a bandwidth allocation policy that results in lower transmission delay, a priority level associated with a time sensitive communication (TSC), a high priority level, a priority level based on an integer value (e.g., a lower integer value may indicate a higher priority level), and/or the like. In an example, the second priority level may include at least one of a low priority level, a priority level associated with a delay tolerant communication, and/or the like.

In an example, the UE may perform a random access procedure for a priority access. In an example, the priority access may include at least one of selecting a priority access configuration in response to receiving paging for reception of downlink data associated with the first priority level, transmitting to the network node a random access message that may include an indication to select the priority access configuration, or monitoring a physical downlink control channel, at least in part, based on the priority access configuration.

In an example, the UE may transmit to the network node, a capability indication of an enhanced paging support for reception of high priority downlink data. The UE may transmit the capability indication to the network node such as the gNB (or a core network node) via a RRC message, a non-access stratum (NAS) message, and/or the like.

In an example, the control channel may include a physical downlink control channel (PDCCH). In an example, the data channel may be a physical downlink shared channel (PDSCH).

In an example, the first priority level may be an enhanced priority level and the second priority level may be a normal priority level.

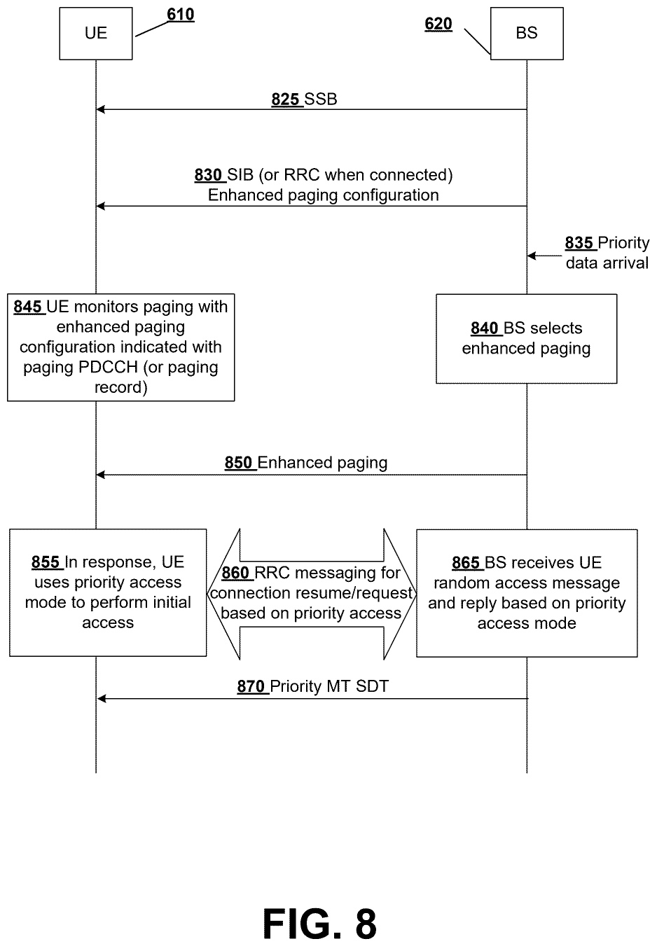

FIG. 8 is a diagram illustrating an aspect of an example embodiment. At 825, the UE 610 may receive SSB from the BS 620. At 830, the BS may configure the UE 610 with an enhanced paging configuration or the first paging configuration via SIB (or via RRC when the UE 610 is connected, e.g., in RRC-CONNECTED state). At 835, the BS 620 may receive high priority downlink data to be transmitted to the UE 610. At 840, the BS 620 may select the first (or enhanced) paging configuration in response to receiving high priority data for the UE 610. At 845, the UE 610 may monitor paging PDCCH (or paging record) e.g., to receive an indication of enhanced paging. At 850, the BS 620 may transmit to UE 610, an indication via paging PDCCH (or paging record PDSCH) informing that it has selected an enhanced paging configuration (e.g., the first paging configuration). The BS 620 may transmit the paging according to the enhanced paging configuration. At 855, the UE 610 may perform a priority access by transmitting a random access request with a priority access indication. At 860, the UE 610 may transmit RRC messages to establish or resume the RRC connection for the priority access. at 865, the BS 620 may receive from the UE 610, random access request with the indication of priority access and may transmit RAR, RRC messages, and/or the like to the UE 610. At 870, the BS 620 may transmit downlink data (or SDT) to the UE 610 based on the priority access.

In an example embodiment, the UE may be configured with at least a first paging configuration or an enhanced paging configuration (e.g., in addition to a normal paging configuration). The enhanced paging configuration may be for triggering the exchange (or reception of) of high priority data, while the normal paging configuration may be for exchange (or reception) of normal data. The enhanced paging configuration may be defined with a single PCCH configuration (e.g., common paging frame (PF)/PO for enhanced or normal paging) but with different PDCCH/PDSCH/RACH configurations versus normal paging. Alternatively, the enhanced paging configuration may use different PF/PO occasions than normal paging, which may follow different DRX cycles, and in this case the UE may wake up for the PO occasion indicated via a WUS. In an example, the enhanced paging configuration may have different PDCCH configurations (e.g., different CORESET and/or paging search space configurations) compared to normal paging configuration. For example, enhanced paging CORESET may be wideband and search space may have smaller or shorter monitoring periodicity (e.g., monitoring occasions may be closer to each other in time), while normal paging CORESET may be narrowband and search space may have a larger monitoring slot periodicity (e.g., monitoring occasions may be more spread out in time).

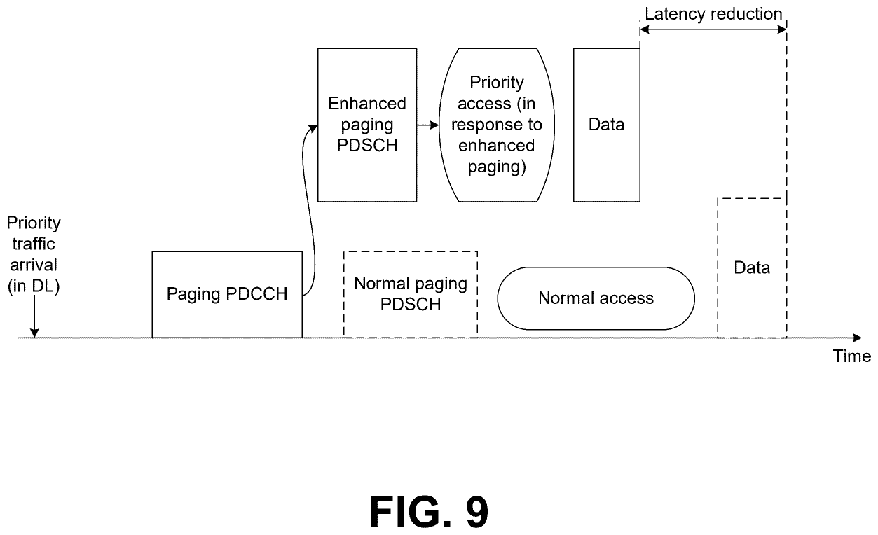

FIG. 9 is a diagram illustrating an aspect of an example embodiment. In an example, the PDCCH configurations of enhanced paging configuration may be in a different DL BWP configuration versus PDCCH of normal paging configuration. In an alternative implementation, a single PDCCH configuration may be available for paging, with an indication in the PDCCH indicating whether to monitor the PDSCH (carrying the paging records) corresponding to the normal DL BWP/PDSCH configuration (narrowband) or enhanced DL BWP/PDSCH configuration (wideband). In an example, the indication in the PDCCH may be provided either through a spare bit or by using of a new P-RNTI for enhanced paging.

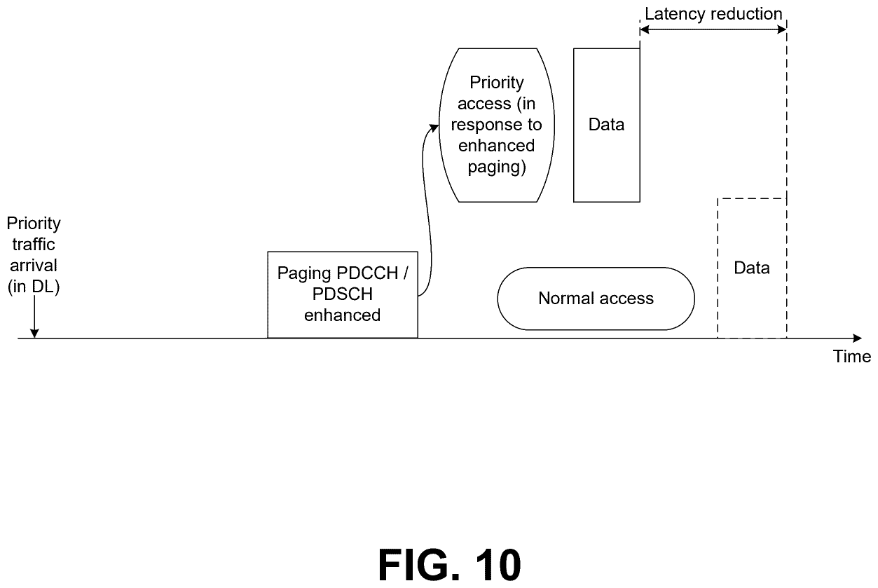

FIG. 10 is a diagram illustrating an aspect of an example embodiment. In an example, an alternative solution may include implementation based on paging message/record. For example, a field (e.g., one bit) in paging record PDSCH may indicate that the enhanced paging configuration is to be selected and/or the enhanced paging is to be performed.

In an example, the UE may be provided with additional configuration information about UE required procedures to receive paging with enhanced paging configuration. For example, the additional configuration information may indicate whether the UE needs to perform additional synchronization, or synchronize over different synchronization resources, or different synchronization signals. In an example, the UE may receive the configuration of the multiple paging configurations from the network node that may be subject to (or based on) the UE capability indication, wherein the UE may indicate (to the network node) its capability of monitoring/supporting multiple paging configurations (and PDSCH) reception. The capability indication may include further details about the characteristic of supported PO and UE behavior when monitoring the PO. In an example, the network may provide further information on the validity of enhanced paging configuration. Enhanced paging configuration may be valid for a certain duration, or while UE is in specific conditions (e.g., battery level, mobility state) or supporting specific feature(s).

In an example, if a WUS is configured, in response to receiving a WUS indicating enhanced paging configuration (e.g., the first paging configuration), the UE may monitor the paging using the enhanced paging configuration. In an example, when WUS is not configured, the UE may unconditionally monitor the paging using enhanced paging configuration at least during its DRX-ON duration. Alternatively, in response to receiving PDCCH in the PO indicating the enhanced paging configuration for the PDSCH (carrying the paging record), the UE may interpret the DCI to correspond to the enhanced paging configuration for the PDSCH (e.g., enhanced DL BWP/PDSCH configuration) and may receive the PDSCH accordingly.

In an example, the network may send paging with both the enhanced paging configuration and the normal paging configurations (if available) to improve the paging reliability. The UE may monitor using both paging configurations in case it may possibly miss the enhanced paging, e.g. due to fading, interference, skipping, and/or the like.

In an example, if priority access is configured, in response to receiving paging with enhanced paging configuration, the UE may perform random access using priority access configuration (e.g., the UE may further follow part of the priority access procedure in response to receiving paging with the enhanced paging configuration).

In an example, the UE may indicate to the network node (gNB) to revert to normal paging and access configuration, (e.g., by replying using a preamble assigned for normal access indication) e.g., in case the UE determines to keep operating in normal BWP/CORESET for power saving purposes. Therefore, the network node or the gNB may determine to use the normal configuration for the subsequent RRC messaging and data transmission(s).

In an example, if the UE is not able to successfully perform random access using the priority access configuration after receiving an indication to receive paging using the enhanced paging configuration, the UE may revert to random access using the normal access configuration.

In an example embodiment, if the UE has moved from the last known cell, it may cause a lot of delay to reach the UE in the RAN notification area (RNA), because the network may start by paging on the last known cell and then expand the paging to other cells. In an example, the enhanced paging configuration may be used by network for ensuring that UEs which may have moved to another cell are awakened with low delay. The network that determines to quickly page a UE that may have moved to another cell, may transmit a wake-up indication or WUS for monitoring paging with the enhanced paging configuration on a larger set of cells (e.g., all the cells) of a tracking area. While regular UEs which are not configured with this option may only be triggered to listen for the normal paging. The set of cells where the enhanced paging configuration may be enabled may be exchanged via Xn interface between gNBs.

In another example, for network energy saving, the set of beams which the network is expected to provide paging may be different for normal paging configuration and enhanced paging configuration. For example, the network may page on multiple/all beams when it is triggering paging based on enhanced paging configuration (e.g., for latency reduction of priority data), while for normal paging configuration the network may page on the last serving SSB beam at least until paging escalation is needed. The recommended SSB beams for enhanced paging and normal paging may be exchanged between gNB-CU and gNB-DU. When triggering for monitoring a paging on the beam corresponding to the enhanced paging configuration, the gNB-DU may activate SSB and/or SIBI on the beam if these are deactivated for network energy saving.

In an example, there may be a single PCCH configuration, e.g., a common PF/POs for paging with enhanced paging configuration or normal paging configuration. However, the enhanced paging configuration may have different PDCCH configurations compared to normal paging configuration. Thus, although PF/PO configuration may be the same, the enhanced paging configuration may enable faster paging PDCCH transmission.

In another example, there may be different PCCH configurations, e.g., different PF/POs for paging with enhanced paging configuration versus PF/POs for paging with normal paging configuration.

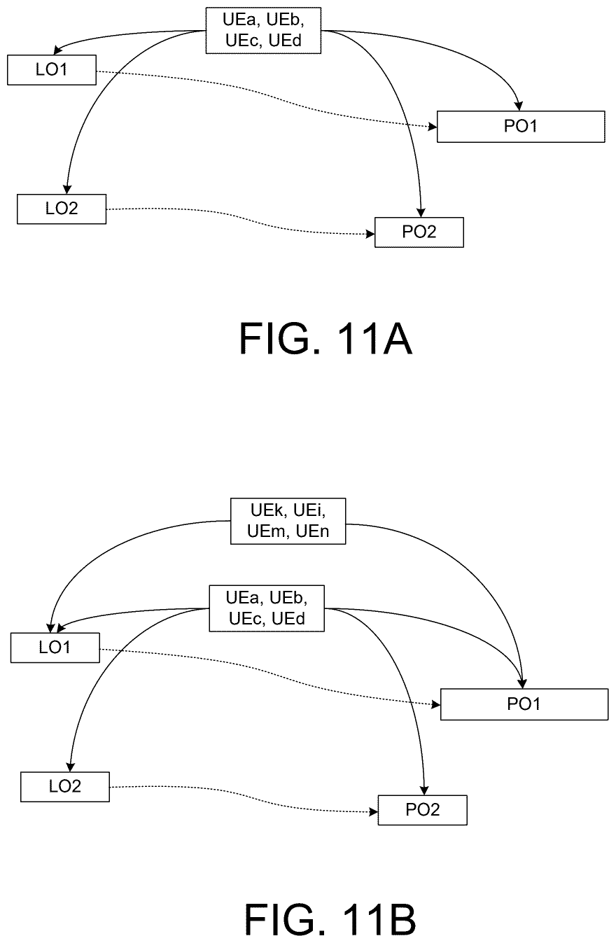

FIG. 11A is a diagram illustrating an example of enhanced paging configuration triggered by WUS for a subgroup of UEs. In this example, UEa, UEb, UEc and UEd may be configured with two paging occasions PO1 and PO2 where paging can be provided with normal paging configuration and enhanced paging configuration respectively. The UEs may monitor for low power WUS occasions (LOs) which indicate which PO to be monitored. In response to receiving LO1, the UEs may wake up for receiving PO1 (e.g., associated with longer DRX cycle, using lower bandwidth and longer in time, or in a LPWA BWP) and in response to receiving LO2 the UEs may wake up for receiving PO2 (e.g., associated with shorter DRX cycle, higher bandwidth, shorter in time, or in eMBB BWP).

FIG. 11B is a diagram illustrating an example of enhanced paging configuration in combination with LP-WUS options for subgroups of UEs. An example embodiment may be applied in combination with different LO and PO configuration options. For example, as illustrated, UEa, UEb, UEc and UEd (e.g., higher capability devices which may be served with higher QoS) may be configured to monitor PO1 and PO2 in response to LO1 and LO2 respectively. While UEk, UEI, UEm and UEn are configured to only monitor PO1, for which LO1 provides the wake-up indication. This means that only the high priority UEs are woken up upon LO2.

In another example, the type of WUS used for indicating enhanced paging configuration may be of a different type (e.g., LP-WUS, group WUS (GWUS), PEI, and/or the like) and configuration (e.g., periodicity/duty cycle, search space, offset) compared to a WUS of normal paging.

Some examples will now be described, based on the description and figures provided herein.

Example 1. An apparatus comprising: at least one processor; and at least one memory storing instructions that, when executed by the at least one processor, cause the apparatus at least to perform: receiving from a network node, a first paging configuration for reception of a paging associated with downlink data, wherein the downlink data is associated with a first priority level, and wherein the first paging configuration is different from a second paging configuration for reception of downlink data that is associated with a second priority level; receiving a wake-up signal (WUS) indicating to monitor a paging for reception of the downlink data associated with the first priority level based on the first paging configuration; receiving, based on the first paging configuration, the paging for reception of the downlink data associated with the first priority level; and receiving the downlink data associated with the first priority level based on the received paging.

Example 2. The apparatus of Example 1, wherein the apparatus is further caused to perform receiving information of mapping between the WUS and a paging configuration, wherein: a first WUS indicates monitoring the paging for reception of the downlink data associated with the first priority level based on the first paging configuration; and a second WUS indicates monitoring the paging for reception of the downlink data associated with the second priority level based on the second paging configuration.

Example 3. The apparatus of Example 1 or 2, wherein the indicating by the WUS is based on a single bit indicated by the WUS.

Example 4. The apparatus of any of Examples 1 to 3, wherein the WUS indicating to monitor the paging for reception of the downlink data associated with the first priority level is associated with an enhanced paging early indication radio network temporary identifier (ePEI-RNTI).

Example 5. The apparatus of any of Examples 1 to 4, wherein the WUS indicating to monitor the paging for reception of the downlink data associated with the first priority level is associated with a dedicated WUS time-frequency occasion.

Example 6. The apparatus of any of Examples 1 to 5, wherein the WUS indicating to monitor the paging for reception of the downlink data associated with the first priority level is associated with a dedicated WUS sequence, wherein the receiving the paging for reception of the downlink data associated with the first priority level is based on receiving the dedicated WUS sequence.

Example 7. The apparatus of any of Examples 1 to 6, wherein the first paging configuration of the paging comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 8. The apparatus of any of Examples 1 to 7, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 9. The apparatus of any of Examples 1 to 8, wherein the first paging configuration and the second paging configuration are associated with a same paging occasion and paging frame.

Example 10. The apparatus of any of Examples 1 to 9, wherein the apparatus is further caused to perform receiving information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 11. The apparatus of any of Examples 1 to 10, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 12. The apparatus of any of Examples 1 to 11, wherein the first paging configuration or the second paging configuration is received via at least one of: a system information block; or a radio resource control (RRC) message.

Example 13. The apparatus of any of Examples 1 to 12, wherein: the first priority level comprises at least one of: a priority level associated with a queuing policy with lower queuing delay; a priority level associated with a bandwidth allocation policy that results in lower transmission delay; a priority level associated with a time sensitive communication; a high priority level; or a priority level based on an integer value, wherein a lower integer value indicates a higher priority level; and the second priority level comprises at least one of: a low priority level; or a priority level associated with a delay tolerant communication.

Example 14. The apparatus of any of Examples 1 to 13, wherein the apparatus is further caused to perform monitoring for the WUS.

Example 15. The apparatus of any of Examples 1 to 14, wherein the apparatus is further caused to perform performing a random access procedure for a priority access, wherein the priority access comprises at least one of: selecting a priority access configuration in response to receiving paging for reception of downlink data associated with the first priority level; transmitting, to the network node, a random access message comprising an indication to select the priority access configuration; or monitoring, a physical downlink control channel based, at least partially, on the priority access configuration.

Example 16. The apparatus of any of Examples 1 to 15, wherein the receiving the paging comprises: receiving, based on the first paging configuration, a control channel, wherein the control channel schedules a data channel carrying a paging message for reception of the downlink data associated with the first priority level.

Example 17. The apparatus of Example 16, wherein the receiving the paging comprises: receiving the data channel based on the first paging configuration.

Example 18. The apparatus of Example 16 or 17, wherein the control channel comprises an indication of whether a downlink control information (DCI) corresponds to the data channel scheduled for an enhanced paging, and whether to monitor the data channel for a normal paging or for an enhanced paging.

Example 19. The apparatus of Example 18, wherein the indication is at least one of: a single bit; a cyclic redundancy check (CRC) scrambled by an enhanced paging RNTI (CP-RNTI); or a P-RNTI associated with the enhanced paging or the normal paging.

Example 20. The apparatus of any of Examples 1 to 19, wherein the apparatus is further caused to perform transmitting to the network node a capability indication of an enhanced paging support for reception of downlink data associated with the first priority level.

Example 21. The apparatus of any of Examples 1 to 20, wherein the first priority level is an enhanced priority level and the second priority level is a normal priority level.

Example 22. An apparatus comprising: at least one processor; and at least one memory storing instructions that, when executed by the at least one processor, cause the apparatus at least to perform: transmitting to a user device, a first paging configuration for reception of a paging associated with downlink data, wherein the downlink data is associated with a first priority level, and wherein the first paging configuration is different from a second paging configuration for reception of downlink data that is associated with a second priority level; transmitting a wake-up signal (WUS) indicating to monitor a paging for reception of the downlink data by the user device associated with the first priority level based on the first paging configuration; transmitting, based on the first paging configuration, the paging for reception of the downlink data associated with the first priority level; and transmitting the downlink data associated with the first priority level.

Example 23. The apparatus of Example 22, wherein the apparatus is further caused to perform transmitting information of mapping between the WUS and a paging configuration, wherein: a first WUS indicates monitoring the paging for reception of the downlink data associated with the first priority level based on the first paging configuration; and a second WUS indicates monitoring the paging for reception of the downlink data associated with the second priority level based on the second paging configuration.

Example 24. The apparatus of Example 22 or 23, wherein the indicating by the WUS is based on a single bit indicated by the WUS.

Example 25. The apparatus of any of Examples 22 to 24, wherein the WUS indicating to monitor the paging for reception of the downlink data associated with the first priority level is associated with an enhanced paging early indication radio network temporary identifier (ePEI-RNTI).

Example 26. The apparatus of any of Examples 22 to 25, wherein the WUS indicating to monitor the paging for reception of the downlink data associated with the first priority level is associated with a dedicated WUS time-frequency occasion.

Example 27. The apparatus of any of Examples 22 to 26, wherein the WUS indicating to monitor the paging for reception of the downlink data associated with the first priority level is associated with a dedicated WUS sequence.

Example 28. The apparatus of any of Examples 22 to 27, wherein the first paging configuration of the paging comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 29. The apparatus of any of Examples 22 to 28, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 30. The apparatus of any of Examples 22 to 29, wherein the first paging configuration and the second paging configuration are associated with a same paging occasion and paging frame.

Example 31. The apparatus of any of Examples 22 to 30, wherein the apparatus is further caused to perform transmitting information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 32. The apparatus of any of Examples 22 to 31, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 33. The apparatus of any of Examples 22 to 32, wherein the first paging configuration or the second paging configuration is transmitted via at least one of: a system information block; or a radio resource control (RRC) message.

Example 34. The apparatus of any of Examples 22 to 33, wherein: the first priority level comprises at least one of: a priority level associated with a queuing policy with lower queuing delay; a priority level associated with a bandwidth allocation policy that results in lower transmission delay; a priority level associated with a time sensitive communication; a high priority level; or a priority level based on an integer value, wherein a lower integer value indicates a higher priority level; and the second priority level comprises at least one of: a low priority level; or a priority level associated with a delay tolerant communication.

Example 35. The apparatus of any of Examples 22 to 34, wherein the transmitting the paging comprises: transmitting, based on the first paging configuration, a control channel, wherein the control channel schedules a data channel carrying a paging message for reception of the downlink data associated with the first priority level.

Example 36. The apparatus of Example 35, wherein the transmitting the paging comprises transmitting the data channel, based on the first paging configuration.

Example 37. The apparatus of Examples 35 or 36, wherein the control channel comprises an indication of whether a downlink control information (DCI) corresponds to the data channel scheduled for an enhanced paging, and whether to monitor the data channel for a normal paging or for an enhanced paging.

Example 38. The apparatus of Example 37, wherein the indication is at least one of: a single bit; a cyclic redundancy check (CRC) scrambled by an enhanced paging RNTI (CP-RNTI); or a P-RNTI associated with the enhanced paging or the normal paging.

Example 39. The apparatus of any of Examples 22 to 38, wherein the apparatus is further caused to perform receiving a capability indication of an enhanced paging support for reception of downlink data associated with the first priority level.

Example 40. The apparatus of any of Examples 22 to 39, wherein the first priority level is an enhanced priority level and the second priority level is a normal priority level.

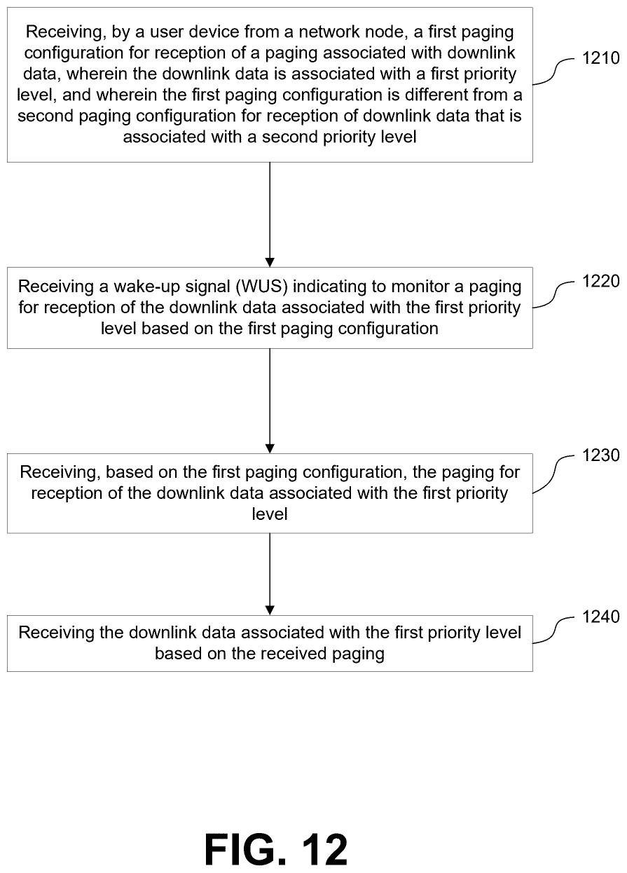

FIG. 12 is a flow chart illustrating operation of an apparatus (e.g., which may be a UE or user device, or other apparatus) according to an example embodiment.

Example 41. FIG. 12 is a flow chart illustrating operation of an apparatus (e.g., which may be a UE or user device, or other apparatus) according to an example embodiment. Operation 1210 includes receiving, by a user device from a network node, a first paging configuration for reception of a paging associated with downlink data, wherein the downlink data is associated with a first priority level, and wherein the first paging configuration is different from a second paging configuration for reception of downlink data that is associated with a second priority level. Operation 1220 includes receiving a wake-up signal (WUS) indicating to monitor a paging for reception of the downlink data associated with the first priority level based on the first paging configuration. Operation 1230 includes receiving, based on the first paging configuration, the paging for reception of the downlink data associated with the first priority level. Operation 1240 includes receiving the downlink data associated with the first priority level based on the received paging.

Example 42. The method of Example 41, further comprising receiving information of mapping between the WUS and a paging configuration, wherein: a first WUS indicates monitoring the paging for reception of the downlink data associated with the first priority level based on the first paging configuration; and a second WUS indicates monitoring the paging for reception of the downlink data associated with the second priority level based on the second paging configuration.

Example 43. The method of Example 41 or 42, wherein the indicating by the WUS is based on a single bit indicated by the WUS.

Example 44. The method of any of Examples 41 to 43, wherein the WUS indicating to monitor the paging for reception of the downlink data associated with the first priority level is associated with an enhanced paging early indication radio network temporary identifier (ePEI-RNTI).

Example 45. The method of any of Examples 41 to 44, wherein the WUS indicating to monitor the paging for reception of the downlink data associated with the first priority level is associated with a dedicated WUS time-frequency occasion.

Example 46. The method of any of Examples 41 to 45, wherein the WUS indicating to monitor the paging for reception of the downlink data associated with the first priority level is associated with a dedicated WUS sequence, wherein the receiving the paging for reception of the downlink data associated with the first priority level is based on receiving the dedicated WUS sequence.

Example 47. The method of any of Examples 41 to 46, wherein the first paging configuration of the paging comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 48. The method of any of Examples 41 to 47, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 49. The method of any of Examples 41 to 48, wherein the first paging configuration and the second paging configuration are associated with a same paging occasion and paging frame.

Example 50. The method of any of Examples 41 to 49, further comprising receiving information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 51. The method of any of Examples 41 to 50, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter thana time period of the normal paging; or the enhanced paging uses a larger downlink bandwidth part (BWP) than the normal paging.

Example 52. The method of any of Examples 41 to 51, wherein the first paging configuration or the second paging configuration is received via at least one of: a system information block; or a radio resource control (RRC) message.

Example 53. The method of any of Examples 41 to 52, wherein: the first priority level comprises at least one of: a priority level associated with a queuing policy with lower queuing delay; a priority level associated with a bandwidth allocation policy that results in lower transmission delay; a priority level associated with a time sensitive communication; a high priority level; or a priority level based on an integer value, wherein a lower integer value indicates a higher priority level; and the second priority level comprises at least one of: a low priority level; or a priority level associated with a delay tolerant communication.

Example 54. The method of any of Examples 41 to 53, further comprising monitoring for the WUS.

Example 55. The method of any of Examples 41 to 54, further comprising performing a random access procedure for a priority access, wherein the priority access comprises at least one of: selecting a priority access configuration in response to receiving paging for reception of downlink data associated with the first priority level; transmitting, to the network node, a random access message comprising an indication to select the priority access configuration; or monitoring, a physical downlink control channel based, at least partially, on the priority access configuration.

Example 56. The method of any of Examples 41 to 55, wherein the receiving the paging comprises: receiving, based on the first paging configuration, a control channel, wherein the control channel schedules a data channel carrying a paging message for reception of the downlink data associated with the first priority level.

Example 57. The method of Example 56, wherein the receiving the paging comprises: receiving the data channel based on the first paging configuration.

Example 58. The method of Example 56 or 57, wherein the control channel comprises an indication of whether a downlink control information (DCI) corresponds to the data channel scheduled for an enhanced paging, and whether to monitor the data channel for a normal paging or for an enhanced paging.

Example 59. The method of Example 58, wherein the indication is at least one of: a single bit; a cyclic redundancy check (CRC) scrambled by an enhanced paging RNTI (CP-RNTI); or a P-RNTI associated with the enhanced paging or the normal paging.

Example 60. The method of any of Examples 41 to 59, further comprising transmitting to the network node a capability indication of an enhanced paging support for reception of downlink data associated with the first priority level.

Example 61. The method of any of Examples 41 to 60, wherein the first priority level is an enhanced priority level and the second priority level is a normal priority level.

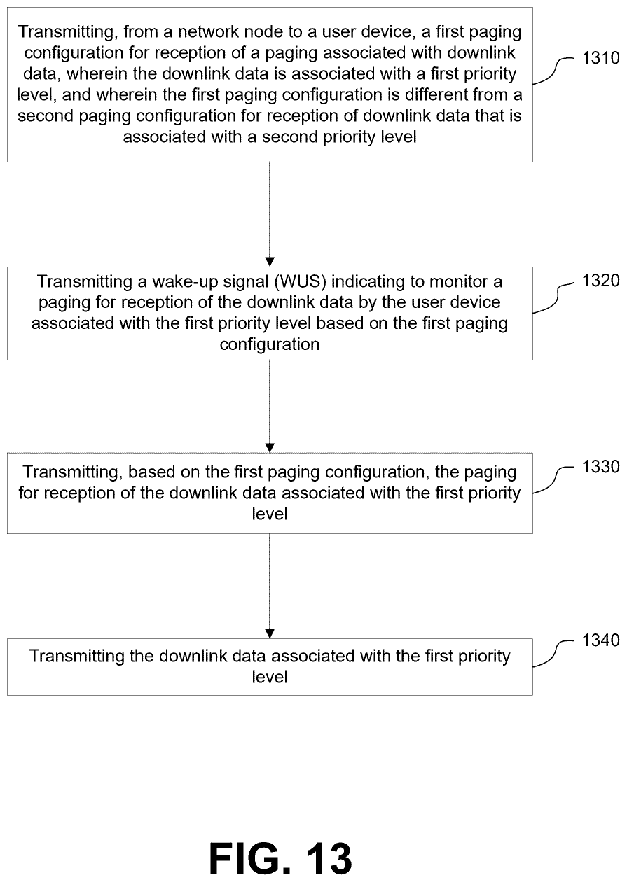

FIG. 13 is a flow chart illustrating operation of an apparatus (e.g., which may be a gNB or network node, or other apparatus) according to an example embodiment.

Example 62. FIG. 13 is a flow chart illustrating operation of an apparatus (e.g., which may be a gNB or network node, or other apparatus) according to an example embodiment. Operation 1310 includes transmitting, from a network node to a user device, a first paging configuration for reception of a paging associated with downlink data, wherein the downlink data is associated with a first priority level, and wherein the first paging configuration is different from a second paging configuration for reception of downlink data that is associated with a second priority level. Operation 1320 includes transmitting a wake-up signal (WUS) indicating to monitor a paging for reception of the downlink data by the user device associated with the first priority level based on the first paging configuration. Operation 1330 includes transmitting, based on the first paging configuration, the paging for reception of the downlink data associated with the first priority level. Operation 1340 includes transmitting the downlink data associated with the first priority level.

Example 63. The method of Example 62, further comprising transmitting information of mapping between the WUS and a paging configuration, wherein: a first WUS indicates monitoring the paging for reception of the downlink data associated with the first priority level based on the first paging configuration; and a second WUS indicates monitoring the paging for reception of the downlink data associated with the second priority level based on the second paging configuration.

Example 64. The method of Example 62 or 63, wherein the indicating by the WUS is based on a single bit indicated by the WUS.

Example 65. The method of any of Examples 62 to 64, wherein the WUS indicating to monitor the paging for reception of the downlink data associated with the first priority level is associated with an enhanced paging early indication radio network temporary identifier (cPEI-RNTI).

Example 66. The method of any of Examples 62 to 65, wherein the WUS indicating to monitor the paging for reception of the downlink data associated with the first priority level is associated with a dedicated WUS time-frequency occasion.

Example 67. The method of any of Examples 62 to 66, wherein the WUS indicating to monitor the paging for reception of the downlink data associated with the first priority level is associated with a dedicated WUS sequence.

Example 68. The method of any of Examples 62 to 67, wherein the first paging configuration of the paging comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 69. The method of any of Examples 62 to 68, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 70. The method of any of Examples 62 to 69, wherein the first paging configuration and the second paging configuration are associated with a same paging occasion and paging frame.

Example 71. The method of any of Examples 62 to 70, further comprising transmitting information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 72. The method of any of Examples 62 to 71, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 73. The method of any of Examples 62 to 72, wherein the first paging configuration or the second paging configuration is transmitted via at least one of: a system information block; or a radio resource control (RRC) message.

Example 74. The method of any of Examples 62 to 73, wherein: the first priority level comprises at least one of: a priority level associated with a queuing policy with lower queuing delay; a priority level associated with a bandwidth allocation policy that results in lower transmission delay; a priority level associated with a time sensitive communication; a high priority level; or a priority level based on an integer value, wherein a lower integer value indicates a higher priority level; and the second priority level comprises at least one of: a low priority level; or a priority level associated with a delay tolerant communication.

Example 75. The method of any of Examples 62 to 74, wherein the transmitting the paging comprises: transmitting, based on the first paging configuration, a control channel, wherein the control channel schedules a data channel carrying a paging message for reception of the downlink data associated with the first priority level.

Example 76. The method of Example 75, wherein the transmitting the paging comprises transmitting the data channel, based on the first paging configuration.

Example 77. The method of Example 75 or 76, wherein the control channel comprises an indication of whether a downlink control information (DCI) corresponds to the data channel scheduled for an enhanced paging, and whether to monitor the data channel for a normal paging or for an enhanced paging.

Example 78. The method of Example 77, wherein the indication is at least one of: a single bit; a cyclic redundancy check (CRC) scrambled by an enhanced paging RNTI (eP-RNTI); or a P-RNTI associated with the enhanced paging or the normal paging.

Example 79. The method of any of Examples 62 to 78, further comprising receiving a capability indication of an enhanced paging support for reception of downlink data associated with the first priority level.

Example 80. The method of any of Examples 62 to 79, wherein the first priority level is an enhanced priority level and the second priority level is a normal priority level.

Example 81. An apparatus comprising: at least one processor; and at least one memory storing instructions that, when executed by the at least one processor, cause the apparatus at least to perform: receiving from a network node, a first paging configuration for reception of a paging message associated with downlink data, wherein the downlink data is associated with a first priority level, and wherein the first paging configuration is different from a second paging configuration for reception of downlink data that is associated with a second priority level; receiving a control channel, wherein the control channel schedules a data channel carrying the paging message for reception of the downlink data associated with the first priority level, and wherein the control channel comprises an indication that the paging message is for reception of the downlink data with the first priority level; receiving the data channel, based on the first paging configuration; and receiving the downlink data associated with the first priority level based on the received paging message.

Example 82. The apparatus of Example 81, wherein the first paging configuration comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 83. The apparatus of Example 81 or 82, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 84. The apparatus of any of Examples 81-83, wherein the first paging configuration and the second paging configuration are associated with a same paging occasion and paging frame.

Example 85. The apparatus of any of Examples 81-84, wherein the indication is at least one of: a single bit; a cyclic redundancy check (CRC) scrambled by an enhanced paging RNTI (eP-RNTI); or a P-RNTI associated with the enhanced paging or the normal paging.

Example 86. The apparatus of any of Examples 81 to 85, wherein the apparatus is further caused to perform receiving information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 87. The apparatus of any of Examples 81 to 86, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 88. The apparatus of any of Examples 81 to 87, wherein the first paging configuration or the second paging configuration is received via at least one of: a system information block; or a radio resource control (RRC) message.

Example 89. The apparatus of any of Examples 81 to 88, wherein: the first priority level comprises at least one of: a priority level associated with a queuing policy with lower queuing delay; a priority level associated with a bandwidth allocation policy that results in lower transmission delay; a priority level associated with a time sensitive communication; a high priority level; or a priority level based on an integer value, wherein a lower integer value indicates a higher priority level; and the second priority level comprises at least one of: a low priority level; or a priority level associated with a delay tolerant communication.

Example 90. The apparatus of any of Examples 81 to 89, wherein the apparatus is further caused to perform monitoring a WUS.

Example 91. The apparatus of any of Examples 81 to 90, wherein the apparatus is further caused to perform performing a random access procedure for a priority access, wherein the priority access comprises at least one of: selecting a priority access configuration in response to receiving paging for reception of downlink data associated with the first priority level; transmitting, to the network node, a random access message comprising an indication to select the priority access configuration; or monitoring, a physical downlink control channel based, at least partially, on the priority access configuration.

Example 92. The apparatus of any of Examples 81 to 91, wherein the apparatus is further caused to perform transmitting to the network node a capability indication of an enhanced paging support for reception of high priority downlink data.

Example 93. The apparatus of any of Examples 81 to 92, wherein the control channel comprises a physical downlink control channel (PDCCH) and wherein the data channel is a physical downlink shared channel (PDSCH).

Example 94. The apparatus of any of Examples 81 to 93, wherein the first priority level is an enhanced priority level and the second priority level is a normal priority level.

Example 95. An apparatus comprising: at least one processor; and at least one memory storing instructions that, when executed by the at least one processor, cause the apparatus at least to perform: transmitting to a user device, a first paging configuration for reception of a paging message associated with downlink data, wherein the downlink data is associated with a first priority level, and wherein the first paging configuration is different from a second paging configuration for reception of downlink data that is associated with a second priority level; transmitting a control channel, wherein the control channel schedules a data channel carrying the paging message for reception of the downlink data associated with the first priority level, and wherein the control channel comprises an indication that the paging message is for reception of the downlink data by the user device with the first priority level; transmitting the data channel, based on the first paging configuration; and transmitting the downlink data associated with the first priority level.

Example 96. The apparatus of Example 95, wherein the first paging configuration comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 97. The apparatus of Example 95 or 96, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 98. The apparatus of any of Examples 95-97, wherein the first paging configuration and the second paging configuration are associated with a same paging occasion and paging frame.

Example 99. The apparatus of any of Examples 95-98, wherein the indication is at least one of: a single bit; a cyclic redundancy check (CRC) scrambled by an enhanced paging RNTI (eP-RNTI); or a P-RNTI associated with the enhanced paging or the normal paging.

Example 100. The apparatus of any of Examples 95 to 99, wherein the apparatus is further caused to perform transmitting information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 101. The apparatus of any of Examples 95 to 100, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 102. The apparatus of any of Examples 95 to 101, wherein the first paging configuration or the second paging configuration is transmitted via at least one of: a system information block; or a radio resource control (RRC) message.

Example 103. The apparatus of any of Examples 95 to 102, wherein the first priority level comprises at least one of: a priority level associated with a queuing policy with lower queuing delay; a priority level associated with a bandwidth allocation policy that results in lower transmission delay; a high priority level; or a priority level based on an integer value, wherein a lower integer value indicates a higher priority level and the second priority level comprises at least one of: a low priority level; or a priority level associated with a delay tolerant communication.

Example 104. The apparatus of any of Examples 95 to 103, wherein the apparatus is further caused to perform transmitting a WUS.

Example 105. The apparatus of any of Examples 95 to 104, wherein the apparatus is further caused to perform receiving a capability indication of an enhanced paging support for reception of high priority downlink data.

Example 106. The apparatus of any of Examples 95 to 105, wherein the control channel comprises a physical downlink control channel (PDCCH) and wherein the data channel is a physical downlink shared channel (PDSCH).

Example 107. The apparatus of any of Examples 95 to 106, wherein the first priority level is an enhanced priority level and the second priority level is a normal priority level.

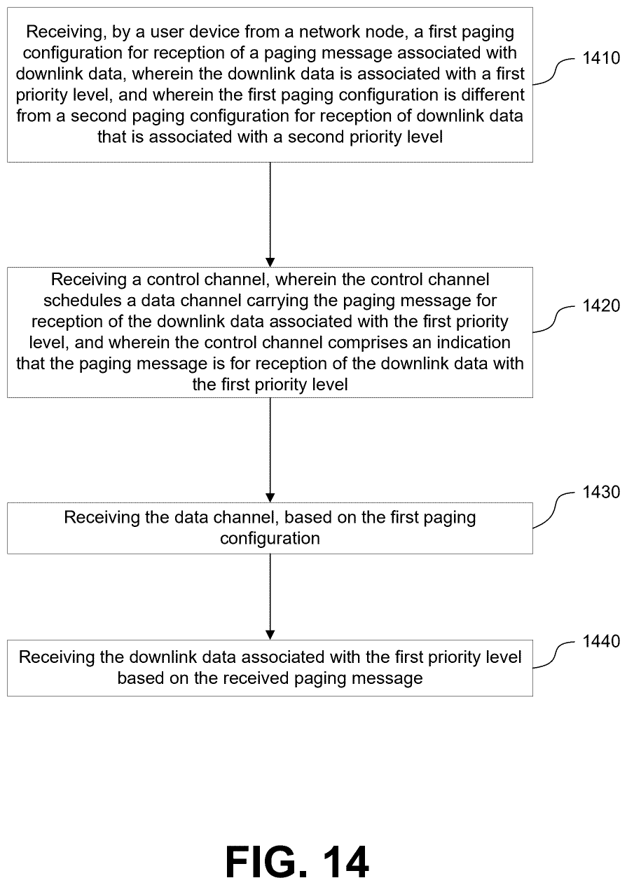

FIG. 14 is a flow chart illustrating operation of an apparatus (e.g., which may be a UE or user device, or other apparatus) according to an example embodiment.

Example 108. FIG. 14 is a flow chart illustrating operation of an apparatus (e.g., which may be a UE or user device, or other apparatus) according to an example embodiment. Operation 1410 includes receiving, by a user device from a network node, a first paging configuration for reception of a paging message associated with downlink data, wherein the downlink data is associated with a first priority level, and wherein the first paging configuration is different from a second paging configuration for reception of downlink data that is associated with a second priority level. Operation 1420 includes receiving a control channel, wherein the control channel schedules a data channel carrying the paging message for reception of the downlink data associated with the first priority level, and wherein the control channel comprises an indication that the paging message is for reception of the downlink data with the first priority level. Operation 1430 includes receiving the data channel, based on the first paging configuration. Operation 1440 includes receiving the downlink data associated with the first priority level based on the received paging message.

Example 109. The method of Example 108, wherein the first paging configuration comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 110. The method of Example 108 or 109, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 111. The method of any of Examples 108-110, wherein the first paging configuration and the second paging configuration are associated with a same paging occasion and paging frame.

Example 112. The method of any of Examples 108-111, wherein the indication is at least one of: a single bit; a cyclic redundancy check (CRC) scrambled by an enhanced paging RNTI (eP-RNTI); or a P-RNTI associated with the enhanced paging or the normal paging.

Example 113. The method of any of Examples 108 to 112, further comprising receiving information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 114. The method of any of Examples 108 to 113, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 115. The method of any of Examples 108 to 114, wherein the first paging configuration or the second paging configuration is received via at least one of: a system information block; or a radio resource control (RRC) message.

Example 116. The method of any of Examples 108 to 115, wherein: the first priority level comprises at least one of: a priority level associated with a queuing policy with lower queuing delay; a priority level associated with a bandwidth allocation policy that results in lower transmission delay; a priority level associated with a time sensitive communication; a high priority level; or a priority level based on an integer value, wherein a lower integer value indicates a higher priority level; and the second priority level comprises at least one of: a low priority level; or a priority level associated with a delay tolerant communication.

Example 117. The method of any of Examples 108 to 116, further comprising monitoring a WUS.

Example 118. The method of any of Examples 108 to 117, further comprising performing a random access procedure for a priority access, wherein the priority access comprises at least one of: selecting a priority access configuration in response to receiving paging for reception of downlink data associated with the first priority level; transmitting, to the network node, a random access message comprising an indication to select the priority access configuration; or monitoring, a physical downlink control channel based, at least partially, on the priority access configuration.

Example 119. The method of any of Examples 108 to 118, further comprising transmitting to the network node a capability indication of an enhanced paging support for reception of high priority downlink data.

Example 120. The method of any of Examples 108 to 119, wherein the control channel comprises a physical downlink control channel (PDCCH) and wherein the data channel is a physical downlink shared channel (PDSCH).

Example 121. The method of any of Examples 108 to 120, wherein the first priority level is an enhanced priority level and the second priority level is a normal priority level.

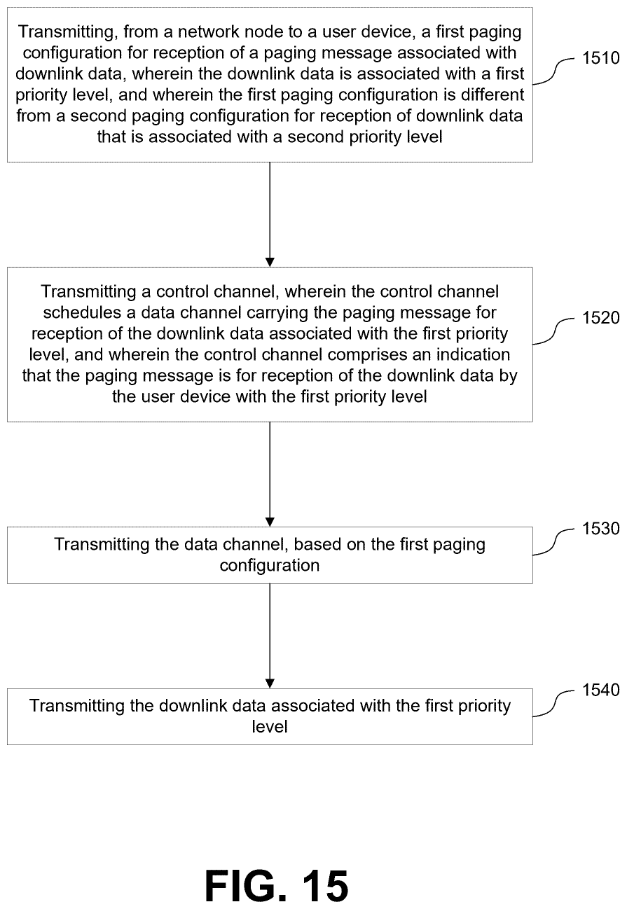

FIG. 15 is a flow chart illustrating operation of an apparatus (e.g., which may be a gNB or network node, or other apparatus) according to an example embodiment.

Example 122. FIG. 15 is a flow chart illustrating operation of an apparatus (e.g., which may be a gNB or network node, or other apparatus) according to an example embodiment. Operation 1510 includes transmitting, from a network node to a user device, a first paging configuration for reception of a paging message associated with downlink data, wherein the downlink data is associated with a first priority level, and wherein the first paging configuration is different from a second paging configuration for reception of downlink data that is associated with a second priority level. Operation 1520 includes transmitting a control channel, wherein the control channel schedules a data channel carrying the paging message for reception of the downlink data associated with the first priority level, and wherein the control channel comprises an indication that the paging message is for reception of the downlink data by the user device with the first priority level. Operation 1530 includes transmitting the data channel, based on the first paging configuration. Operation 1540 includes transmitting the downlink data associated with the first priority level.

Example 123. The method of Example 122, wherein the first paging configuration comprises at least one of: a first configuration information of a paging control channel (PCCH); a first information of a paging occasion; a first information of a paging frame; a first configuration of a control channel scheduling a data channel carrying a paging message; a first configuration of the data channel; a first configuration of a random access channel (RACH); a first configuration of a bandwidth part (BWP); a first configuration of a control resource set (CORESET); a first information of a discontinuous reception (DRX) cycle; a first information of a search space; a first information of a paging radio network temporary identifier (P-RNTI); or a first information of synchronization parameters.

Example 124. The method of Example 122 or 123, wherein the second paging configuration comprises at least one of: a second configuration information of a paging control channel (PCCH); a second information of a paging occasion; a second information of a paging frame; a second configuration of a control channel scheduling a data channel carrying the paging; a second configuration of the data channel; a second configuration of a random access channel (RACH); a second configuration of a bandwidth part (BWP); a second configuration of a control resource set (CORESET); a second information of a discontinuous reception (DRX) cycle; a second information of a search space; a second information of a paging radio network temporary identifier (P-RNTI); or a second information of synchronization parameters.

Example 125. The method of any of Examples 122-124, wherein the first paging configuration and the second paging configuration are associated with a same paging occasion and paging frame.

Example 126. The method of any of Examples 122-125, wherein the indication is at least one of: a single bit; a cyclic redundancy check (CRC) scrambled by an enhanced paging RNTI (eP-RNTI); or a P-RNTI associated with the enhanced paging or the normal paging.

Example 127. The method of any of Examples 122 to 126, further comprising transmitting information indicating at least one of: a validity period associated with at least one of the first paging configuration or the second paging configuration; or a validity condition associated with at least one of the first paging configuration or the second paging configuration, wherein the validity condition is based on at least one of: a battery level; or a mobility state.

Example 128. The method of any of Examples 122 to 127, wherein the first paging configuration is for an enhanced paging for reception of downlink data associated with the first priority level, and the second paging configuration is for a normal paging for reception of downlink data associated with the second priority level, wherein at least one of the following applies: the enhanced paging has a higher bandwidth than a normal paging; paging occasions of the enhanced paging are associated with a higher bandwidth than paging occasions of the normal paging; a periodicity of the enhanced paging is shorter than a periodicity of the normal paging; a time period of the enhanced paging is shorter than a time period of the normal paging; or the enhanced paging uses a larger downlink bandwidth part (BWP) than the normal paging.

Example 129. The method of any of Examples 122 to 128, wherein the first paging configuration or the second paging configuration is transmitted via at least one of: a system information block; or a radio resource control (RRC) message.

Example 130. The method of any of Examples 122 to 129, wherein the first priority level comprises at least one of: a priority level associated with a queuing policy with lower queuing delay; a priority level associated with a bandwidth allocation policy that results in lower transmission delay; a high priority level; or a priority level based on an integer value, wherein a lower integer value indicates a higher priority level and the second priority level comprises at least one of: a low priority level; or a priority level associated with a delay tolerant communication.

Example 131. The method of any of Examples 122 to 130, further comprising transmitting a WUS.

Example 132. The method of any of Examples 122 to 131, further comprising receiving a capability indication of an enhanced paging support for reception of high priority downlink data.

Example 133. The method of any of Examples 122 to 132, wherein the control channel comprises a physical downlink control channel (PDCCH) and wherein the data channel is a physical downlink shared channel (PDSCH).

Example 134. The method of any of Examples 122 to 133, wherein the first priority level is an enhanced priority level and the second priority level is a normal priority level.

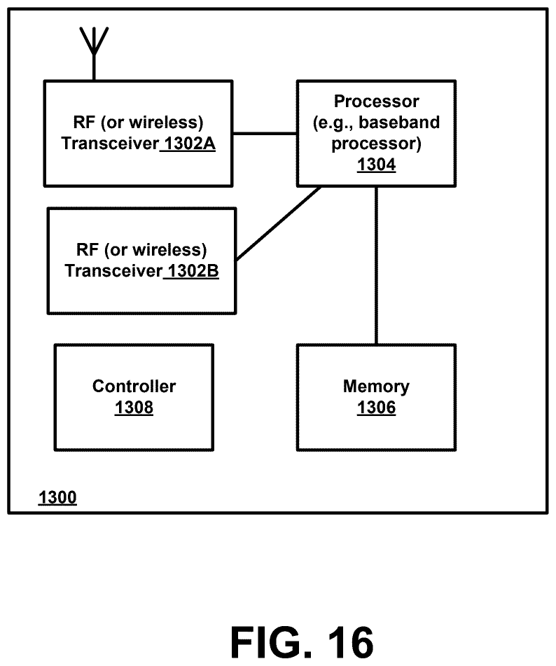

FIG. 16 is a block diagram of a wireless station or node (e.g., UE, user device, AP, BS, eNB, gNB, RAN node, network node, TRP, or other node) 1300 according to an example embodiment. The wireless station 1300 may include, for example, one or more (e.g., two as shown in FIG. 16) RF (radio frequency) or wireless transceivers 1302A, 1302B, where each wireless transceiver includes a transmitter to transmit signals and a receiver to receive signals. The wireless station also includes a processor or control unit/entity (controller) 1304 to execute instructions or software and control transmission and receptions of signals, and a memory 1306 to store data and/or instructions.

Processor 1304 may also make decisions or determinations, generate frames, packets or messages for transmission, decode received frames or messages for further processing, and other tasks or functions described herein. Processor 1304, which may be a baseband processor, for example, may generate messages, packets, frames or other signals for transmission via wireless transceiver 1302 (1302A or 1302B). Processor 1304 may control transmission of signals or messages over a wireless network, and may control the reception of signals or messages, etc., via a wireless network (e.g., after being down-converted by wireless transceiver 1302, for example). Processor 1304 may be programmable and capable of executing software or other instructions stored in memory or on other computer media to perform the various tasks and functions described above, such as one or more of the tasks or methods described above. Processor 1304 may be (or may include), for example, hardware, programmable logic, a programmable processor that executes software or firmware, and/or any combination of these. Using other terminology, processor 1304 and transceiver 1302 together may be considered as a wireless transmitter/receiver system, for example.

In addition, referring to FIG. 16, a controller (or processor) 1308 may execute software and instructions, and may provide overall control for the station 1300, and may provide control for other systems not shown in FIG. 16, such as controlling input/output devices (e.g., display, keypad), and/or may execute software for one or more applications that may be provided on wireless station 1300, such as, for example, an email program, audio/video applications, a word processor, a Voice over IP application, or other application or software.

In addition, a storage medium may be provided that includes stored instructions, which when executed by a controller or processor may result in the processor 1304, or other controller or processor, performing one or more of the functions or tasks described above.

According to another example embodiment, RF or wireless transceiver(s) 1302A/1302B may receive signals or data and/or transmit or send signals or data. Processor 1304 (and possibly transceivers 1302A/1302B) may control the RF or wireless transceiver 1302A or 1302B to receive, send, broadcast or transmit signals or data.

Example embodiments are provided or described for each of the example methods, including: An apparatus (e.g., 1300, FIG. 16) including means (e.g., processor 1304, RF transceivers 1302A and/or 1302B, and/or memory 1306, in FIG. 16) for carrying out any of the methods; a non-transitory computer-readable storage medium (e.g., memory 1306, FIG. 16) comprising instructions stored thereon that, when executed by at least one processor (processor 1304, FIG. 16), are configured to cause a computing system (e.g., 1300, FIG. 16) to perform any of the example methods; and an apparatus (e.g., 1300, FIG. 16) including at least one processor (e.g., processor 1304, FIG. 16), and at least one memory (e.g., memory 1306, FIG. 16) including computer program code, the at least one memory (1306) and the computer program code configured to, with the at least one processor (1304), cause the apparatus (e.g., 1300) at least to perform any of the example methods.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

As used in this application, the term “circuitry” or “circuit” refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of “circuitry” applies to all uses of this term in this application. As a further example, as used in this application, the term “circuitry” would also cover an implementation of merely a processor (or multiple processors) or a portion of a processor and its (or their) accompanying software and/or firmware. The term “circuitry” would also cover, for example and if applicable to the particular element, a baseband integrated circuit or applications processor integrated circuit for a mobile phone or a similar integrated circuit in a server, a cellular network device, or another network device.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer, or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a standalone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a backend component, e.g., as a data server, or that includes a middleware component, e.g., an application server, or that includes a frontend component, e.g., a client computer having a graphical user interface or a Web browser through which a user can interact with an embodiment, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. An apparatus comprising:
at least one processor; and
at least one memory storing instructions that, when executed by the at least one processor, cause the apparatus at least to perform:
receiving from a network node, a first paging configuration for reception of a paging message associated with downlink data, wherein the downlink data is associated with a first priority level, and wherein the first paging configuration is different from a second paging configuration for reception of downlink data that is associated with a second priority level;
receiving a control channel, wherein the control channel schedules a data channel carrying the paging message for reception of the downlink data associated with the first priority level, and wherein the control channel comprises an indication that the paging message is for reception of the downlink data with the first priority level;
receiving the data channel, based on the first paging configuration; and
receiving the downlink data associated with the first priority level based on the received paging message.

2. The apparatus of claim 1, wherein the first paging configuration comprises at least one of:
a first configuration information of a paging control channel (PCCH);
a first information of a paging occasion;
a first information of a paging frame;
a first configuration of a control channel scheduling a data channel carrying a paging message;
a first configuration of the data channel;
a first configuration of a random access channel (RACH);
a first configuration of a bandwidth part (BWP);
a first configuration of a control resource set (CORESET);
a first information of a discontinuous reception (DRX) cycle;
a first information of a search space;
a first information of a paging radio network temporary identifier (P-RNTI); or
a first information of synchronization parameters.

3. The apparatus of claim 1, wherein the second paging configuration comprises at least one of:
a second configuration information of a paging control channel (PCCH);
a second information of a paging occasion;
a second information of a paging frame;
a second configuration of a control channel scheduling a data channel carrying the paging;
a second configuration of the data channel;
a second configuration of a random access channel (RACH);
a second configuration of a bandwidth part (BWP);
a second configuration of a control resource set (CORESET);
a second information of a discontinuous reception (DRX) cycle;
a second information of a search space;
a second information of a paging radio network temporary identifier (P-RNTI); or
a second information of synchronization parameters.

4. The apparatus of claim 1, wherein the first paging configuration and the second paging configuration are associated with a same paging occasion and paging frame.

5. The apparatus of claim 1, wherein the indication is at least one of:
a single bit;
a cyclic redundancy check (CRC) scrambled by an enhanced paging RNTI (eP-RNTI); or
a P-RNTI associated with the enhanced paging or a normal paging.

6. The apparatus of claim 1, wherein the apparatus is further caused to perform receiving information indicating at least one of:
a validity period associated with at least one of the first paging configuration or the second paging configuration; or
a validity condition associated with at least one of the first paging configuration or the second paging configuration, wherein the validity condition is based on at least one of:
a battery level; or
a mobility state.

7. The apparatus of claim 1, wherein the first paging configuration is for an enhanced paging for reception of downlink data associated with the first priority level, and the second paging configuration is for a normal paging for reception of downlink data associated with the second priority level, wherein at least one of the following applies:
the enhanced paging has a higher bandwidth than a normal paging;
paging occasions of the enhanced paging are associated with a higher bandwidth than paging occasions of the normal paging;
a periodicity of the enhanced paging is shorter than a periodicity of the normal paging;
a time period of the enhanced paging is shorter than a time period of the normal paging; or
the enhanced paging uses a larger downlink bandwidth part (BWP) than the normal paging.

8. The apparatus of claim 1, wherein the first paging configuration or the second paging configuration is received via at least one of:
a system information block; or
a radio resource control (RRC) message.

9. The apparatus of claim 1, wherein:
the first priority level comprises at least one of:
a priority level associated with a queuing policy with lower queuing delay;
a priority level associated with a bandwidth allocation policy that results in lower transmission delay;
a priority level associated with a time sensitive communication;
a high priority level; or
a priority level based on an integer value, wherein a lower integer value indicates a higher priority level; and
the second priority level comprises at least one of:
a low priority level; or
a priority level associated with a delay tolerant communication.

10. The apparatus of claim 1, wherein the apparatus is further caused to perform monitoring a WUS.

11. The apparatus of claim 1, wherein the apparatus is further caused to perform performing a random access procedure for a priority access, wherein the priority access comprises at least one of:
selecting a priority access configuration in response to receiving paging for reception of downlink data associated with the first priority level;
transmitting, to the network node, a random access message comprising an indication to select the priority access configuration; or
monitoring, a physical downlink control channel based, at least partially, on the priority access configuration.

12. The apparatus of claim 1, wherein the apparatus is further caused to perform transmitting to the network node a capability indication of an enhanced paging support for reception of high priority downlink data.

13. The apparatus of claim 1, wherein the control channel comprises a physical downlink control channel (PDCCH) and wherein the data channel is a physical downlink shared channel (PDSCH).

14. The apparatus of claim 1, wherein the first priority level is an enhanced priority level and the second priority level is a normal priority level.

15. An apparatus comprising:
at least one processor; and
at least one memory storing instructions that, when executed by the at least one processor, cause the apparatus at least to perform:
transmitting to a user device, a first paging configuration for reception of a paging message associated with downlink data, wherein the downlink data is associated with a first priority level, and wherein the first paging configuration is different from a second paging configuration for reception of downlink data that is associated with a second priority level;
transmitting a control channel, wherein the control channel schedules a data channel carrying the paging message for reception of the downlink data associated with the first priority level, and wherein the control channel comprises an indication that the paging message is for reception of the downlink data by the user device with the first priority level;
transmitting the data channel, based on the first paging configuration; and
transmitting the downlink data associated with the first priority level.

16. The apparatus of claim 15, wherein the first paging configuration comprises at least one of:
a first configuration information of a paging control channel (PCCH);
a first information of a paging occasion;
a first information of a paging frame;
a first configuration of a control channel scheduling a data channel carrying a paging message;
a first configuration of the data channel;
a first configuration of a random access channel (RACH);
a first configuration of a bandwidth part (BWP);
a first configuration of a control resource set (CORESET);
a first information of a discontinuous reception (DRX) cycle;
a first information of a search space;
a first information of a paging radio network temporary identifier (P-RNTI); or
a first information of synchronization parameters.

17. The apparatus of claim 15, wherein the second paging configuration comprises at least one of:
a second configuration information of a paging control channel (PCCH);
a second information of a paging occasion;
a second information of a paging frame;
a second configuration of a control channel scheduling a data channel carrying the paging;
a second configuration of the data channel;
a second configuration of a random access channel (RACH);
a second configuration of a bandwidth part (BWP);
a second configuration of a control resource set (CORESET);
a second information of a discontinuous reception (DRX) cycle;
a second information of a search space;
a second information of a paging radio network temporary identifier (P-RNTI); or
a second information of synchronization parameters.

18. The apparatus of claim 15, wherein the first paging configuration and the second paging configuration are associated with a same paging occasion and paging frame.

19. The apparatus of claim 15, wherein the indication is at least one of:
a single bit;
a cyclic redundancy check (CRC) scrambled by an enhanced paging RNTI (eP-RNTI); or
a P-RNTI associated with the enhanced paging or a normal paging.

20. The apparatus of claim 15, wherein the apparatus is further caused to perform transmitting information indicating at least one of:
a validity period associated with at least one of the first paging configuration or the second paging configuration; or
a validity condition associated with at least one of the first paging configuration or the second paging configuration, wherein the validity condition is based on at least one of:
a battery level; or
a mobility state.
